(19) United States
(12) Patent Application Publication
(10) Pub. No.: US 2026/0079606 A1
(43) Pub. Date: Mar. 19, 2026

(54) GENERATING VIRTUAL CONTENT BLOCKS LINKED TO MULTIPLE MEETINGS

(71) Applicant: Dropbox, Inc., San Francisco, CA (US)

(72) Inventors: Haishan Qian, Toronto (CA); Kyle Arch, Bakersfield, CA (US); Ritu Vincent, Alamo, CA (US); Udara Jayawardena, Toronto (CA); William Adamowicz, Los Angeles, CA (US)

(21) Appl. No.: 18/890,189

(22) Filed: Sep. 19, 2024

(51) Int. Cl. G06F 3/0481; G06F 3/0484; G06F 40/279; G06F 40/40; G10L 15/183

(52) U.S. Cl. CPC G06F 3/0481; G06F 3/0484; G06F 40/279; G06F 40/40; G10L 15/183

(57) ABSTRACT

The present disclosure relates to systems, non-transitory computer-readable media, and methods for generating block content elements from meeting data of multiple video calls to add to data blocks of a virtual space. In particular, in one or more embodiments, the discloses systems utilize a large language model to process meeting data across multiple video calls and generate the block content elements for data blocks. For example, in some embodiments, the disclosed systems generate new block content elements based on detecting meeting data from additional video calls. Further, in one or more embodiments, the disclosed systems generate block content elements according to block type of a data block and extract meeting data to generate summaries, action items, document elements, or dates. Moreover, in some embodiments, the disclosed systems provide options and prompts to generate or update a virtual space using meeting date from video calls.

### BACKGROUND

Advancements in computing devices and networking technology have given rise to a variety of innovations in systems for digitally collaborating and sharing information. For example, through conventional collaboration systems, teams or groups of users can access a central cloud-based repository of information related to projects, tasks, or other collective efforts. In these central repositories, users can add content and other information for display and access by users associated with the task or project. Indeed, many conventional collaboration systems attempt to act as a central hub where users can access and modify content and information for the collective task or project. Despite these advances, however, conventional collaboration systems suffer from a number of disadvantages, particularly in terms of accuracy, efficiency, and flexibility.

For instance, conventional collaboration systems are inaccurate as they capture incomplete collaboration data, particularly data relating to video calls. While conventional collaboration systems can provide platforms and content for collaboration, many existing systems nevertheless cannot integrate video call data from past meetings as part of the collaborative software. Information, event schedules, and project details are often discussed during video calls, such as deadlines or action items assigned to various user accounts. Because of certain complexities involved and the technical limitations in their software infrastructure, conventional systems cannot ingest (much less provide any insight regarding) video call data as manipulable content in a collaboration platform. Consequently, conventional systems focus instead on more rudimentary digital collaboration through digital documents, spreadsheets, and other simultaneously editable content formats, leaving the management of video calls to separate applications or platforms with little to no direct integration. As a result of this siloed infrastructure separating video call data from other collaborative content, conventional systems miss crucial information generated in video calls which impacts other collaborative content items, causing them to reflect incomplete or inaccurate data.

In addition, conventional collaboration systems are inefficient. To elaborate, many conventional collaboration systems require navigating across multiple separate applications (and their respective interfaces) to manage data from a video call and data from a collaborative editing application. Thus, conventional collaboration systems require additional resources to separately and simultaneously run—and render interfaces for—the multiple applications as a user account accesses content for video calls to incorporate into collaborative documents. Not only does running and rendering these separate applications consume excessive amounts of computer processing power and memory (e.g., for cached data of multiple running applications), but navigating across the applications (and their interfaces) is navigationally inefficient as well, requiring excessive numbers of client device interactions to access desired data and/or functionality.

As another example of their drawbacks, conventional collaboration systems are also inflexible. While some conventional collaboration systems can generate transcripts and/or can generate summaries of transcripts for video calls, such systems are nevertheless rigidly fixed to their video call environments. Indeed, they are limited to generating and analyzing transcripts in isolation, unable to adapt or directly integrate generated summaries or other extracted information into already existing collaborative platforms. These, along with additional problems and issues, exist with regard to conventional collaboration systems.

### SUMMARY

This disclosure describes one or more embodiments of systems, methods, and non-transitory computer-readable storage media that provide benefits and/or solve one or more of the foregoing and other problems in the art. For instance, the disclosed systems generate content elements for content blocks by utilizing a large language model to process meeting data across multiple video calls and to generate the content elements for a data block of a virtual space. In some embodiments, the disclosed systems generate a block content element for a data block using data from a video call and, based on receiving or identifying meeting data from an additional video call associated with the virtual space, generate a new content element for the data block. In one or more embodiments, the disclosed systems generate content elements based on a block type of the data block and extract data from meeting data to generate summaries, action items, document elements or dates. Moreover, in one or more embodiments, the disclosed systems provide options and prompts to generate (or update) a virtual space using meeting data from video calls. Additional features and advantages of one or more embodiments of the present disclosure are outlined in the description that follows, and, in part, will be obvious from the description or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a data block integration system can operate in accordance with one or more embodiments.

FIG. 2 illustrates an example diagram of overview of a data block integration system generating a block content element associated with a first video call for a virtual space and generating a new block content element associated with a second video call for the virtual space in accordance with one or more embodiments.

FIG. 3 illustrates a schematic diagram of a data block integration system utilizing a large language model to generate a block content element in accordance with one or more embodiments.

FIGS. 4A-4C illustrate example graphical user interfaces of options for adding meeting data to a virtual space in accordance with one or more embodiments.

FIGS. 5A-5D illustrate example graphical user interfaces of a virtual space of a data block integration system in accordance with one or more embodiments.

FIGS. 6A-6C illustrate example graphical user interfaces of a data block integration system adding a data block to a virtual space in accordance with one or more embodiments.

FIGS. 7A-7B illustrate an example graphical user interface of various data block types for a virtual space of a data block integration system and generating a combined transcript for a transcript block in accordance with one or more embodiments.

FIGS. 8A-8B illustrate example graphical user interfaces depicting a data block integration system adding a video call to a virtual space in accordance with one or more embodiments

FIG. 9 illustrates a flowchart of a series of acts for generating block content elements using data from video calls for data blocks of a virtual space in accordance with one or more embodiments.

FIG. 10 illustrates a block diagram of an example computing device for implementing one or more embodiments of the present disclosure.

FIG. 11 illustrates a network environment of a content management system in accordance with one or more embodiments

### DETAILED DESCRIPTION

This disclosure describes one or more embodiments of a data block integration system that generates virtual data blocks of a virtual space by utilizing a large language model to process meeting data from one or more video calls. In particular, the data block integration system generates block content elements (to include within virtual data blocks) using meeting data from a video call. Based on detecting additional meeting data from a video call, the data block integration system can generate a new block content element for the data block associated with the virtual space and can add the new block content element to the data block. Indeed, the data block integration system can provide a dynamic virtual space that identifies related content across video calls and can intelligently generate block content elements to update and/or generate data blocks in a virtual space.

For example, in one or more embodiments, the data block integration system identifies related content across video calls by analyzing meeting data to determine data, data blocks, and/or virtual spaces associated with meeting data from a video call. For instance, the data block integration system determines that multiple video calls are associated (e.g., corresponding to the same topic) and generates block content elements utilizing the meeting data to update or generate data blocks of a virtual space. In addition, in some cases, based on analyzing the meeting data, the data block integration determines that a video call is associated with an existing virtual space and updates block content elements of data blocks (or generates new data blocks) in the existing virtual space. In some cases, the data block integration system utilizes a large language model to process meeting data (from a video call) for generating block content elements, comparing with existing virtual data blocks, and updating a virtual space with new blocks and/or block content elements.

In some embodiments, the data block integration system generates tailored block content elements based on a block type of a data block. Specifically, the data block integration system can provide a prompt to a large language model to generate a block content element from meeting data based on block content specifications corresponding to a block type. For instance, the data block integration system can instruct a large language model to: 1) extract updates and/or generate summaries for an update block, 2) extract action items for an action item block, 3) identify documents mentioned in the video call and generate document elements for a document block, and/or 4) identify dates (or deadlines) mentioned in the video call for a dates block. In addition, the data block integration system can intelligently identify content in meeting data (or other data associated with the virtual space) that corresponds to additional block types and generates block content elements for additional data blocks for the virtual space. For example, the data block integration system can generate a meeting agenda based on past video call data, generate a transcript (or combined transcript) from a video call for a transcript block, or extract third-party data from a third-party application associated with the virtual space.

In some embodiments, the data block integration system generates a block content element in response to a request to generate or access a virtual space. Indeed, the data block integration system integrates video call data extraction directly into a virtual space of a user account. Thus, data block integration system can receive a selection of an option to generate a virtual space from a video call interface (or a transcript analysis interface) associated with a video call. When generating a virtual space, the data block integration system can generate a set of data blocks and constituent block content elements that fill out a data block. In some cases, the data block integration system determines a block type for a data block, such as an update block, an action block, a document block, and/or a dates block. In existing virtual spaces, the data block integration system can generate block content elements corresponding to a block type and can add the block content elements to the appropriate data blocks.

As mentioned, in one or more embodiments, the data block generation system generates and maintains a virtual space linked to multiple video calls. Accordingly, the data block integration system generates data blocks (and block content elements) from meeting data across the multiple linked video calls. For instance, the data block generation system can generate one block content element from a first video call and can generate another block content element from a second video call. The data block generation system can provide both block content items in a comprehensive virtual space that intelligently and dynamically (and autonomously or automatically) updates based on data from multiple video calls.

As suggested above, and described in further detail below, the data block integration system provides a variety of technical advantages relative to conventional collaboration systems. For example, unlike conventional collaboration systems that simply provide rudimentary digital collaboration through spreadsheets or digital documents and fail to account for video call data, the data block integration system improves accuracy over conventional collaboration systems by integrating extracted (or generated) meeting data into a dynamic virtual space. Specifically, by automatically generating and adding block content elements to content blocks of a virtual space as users of the virtual space participate in video calls, the data block integration system maintains the virtual space with up-to-date information that is viewable and accessible to all users associated with the virtual space. Upon receiving meeting data, the data block integration system uses a large language model to analyze the meeting data and generate block content elements that integrate meeting data into various different data blocks, updating data blocks to incorporate meeting data from multiple video calls, along with third-party data, include action items, deadlines, generate overall summaries, and provide specific meeting updates. Moreover, the data block integration system can even generate and/or update data blocks during video calls, further providing an accurate and up-to-date virtual space for a project or task.

In addition, the data block integration system also improves efficiency relative to conventional collaboration systems. Unlike conventional collaboration systems that require excess computational resources to render and execute various applications and interfaces and require users to navigate accesses various applications to access desired data and/or functionality, the data block integration system intelligently generates a comprehensive virtual space that provides content, data, and information from multiple sources in data blocks of a virtual space. Specifically, the data block integration system accesses data from video calls, content items, and messaging applications, among other data sources, and intelligently generates block content elements for data blocks of a virtual space without needing to render additional interfaces to view collaboration efforts across various systems and interface., The data block generation system uses a large language model, to intelligently and automatically extract various deadlines, action items, generate summaries, generate agendas, and identify documents mentioned and network locations for the documents for block content elements of a virtual space. Indeed, because the data block integration system intelligently detects additional meeting data from additional video calls and data updates and changes in third-party applications connected to the virtual space, the data block integration system provides a dynamic, comprehensive, and up-to-date virtual space that utilizes a single interface and without needing to render additional interfaces or applications.

In addition, the data block integration system increases flexibility over conventional collaboration systems. Unlike conventional collaboration systems that are rigidly fixed to their video call environments and are limited to analyzing transcripts in isolation, as mentioned, the data block generation system can analyze and provide information across several video calls and third-party sources. In particular, the data block generation system utilizes a large language model to generate block content elements that incorporate information from video calls occurring at various times and from multiple users and update data blocks in the virtual space. Moreover, the data block integration system also incorporates data from various third-party systems into block content elements, integrating information from multiple sources into summaries, action items, documents, deadline information, and more into a virtual space.

As illustrated by the foregoing discussion, the present disclosure utilizes a variety of terms to describe features and advantages of the data block integration system. Additional detail is now provided regarding the meaning of such terms. For example, as used herein, the term “block content element” refers to specific data or information included in a virtual data block, such as a discrete and selectable content item. In addition, the term “data block” (or “virtual data block”) refers to a data structure, a data entity, or a data element that is embeddable in multiple virtual spaces concurrently without moving or copying digital content presented within (or incorporated by) the data block. For example, a data block can refer to a data element that corresponds to (or represents) digital content that is presented for display within a virtual space interface. Indeed, a data block can refer to a visualization of multilocational data, where the multilocational data defines the presentation of digital content within the content block. A data block can include multiple data identifiers that refer to (locations of) data elements or computer code that define the digital content to present within a content block. A data block can include self-contained data or information within a structured layout (e.g., within a data block of a virtual space). A block content element can include a single concept, type of data, or content type. To illustrate, a block content element can include text, images, documents (or links to network locations of documents), space for text, summaries, or dates. In some cases, a data block is embeddable for display within a virtual space (or multiple virtual spaces).

Also, as used herein, the term “block type” refers to a concept, category, format, classification, or genre of a data block. Specifically, the term block type refers to a concept or content type of data visualized or included within a data block. For example, a block type is associated with a data block so that a data block displays data corresponding to the block type. To illustrate, a block type can refer to an update block (or summary block), an action item block, a document block, a dates block (or deadline block), a transcript block, a notes block, a suggested block, or an application data block. Relatedly, the term “block content specifications” includes instructions, directions, parameters, or guidelines for block content elements of a block type. Specifically, block content specifications include or represent computer code defining how content for the data block is displayed, generated, or extracted based on the block type. In some cases, a prompt includes block content specifications that instruct a large language model on the specifics for a block content element based on the block type of a data block. For example, block content specifications can indicate content, data, and or other information for a large language model to extract from meeting data for a block content element.

In addition, as used herein, the term “virtual space” refers to a computer-based digital environment that includes embedded data blocks along with contextual data for the data blocks. For instance, a virtual space includes contextual data such as user account data for user accounts with access to data blocks (or multilocational data blocks), thread data for communication threads associated with data blocks, task data for task lists associated with data blocks, meeting data for virtual meetings associated with data blocks, summary data for block summaries of data blocks, and/or other contextual data blocks. In some cases, a virtual space refers to a “virtual space interface” that includes graphical elements representing data blocks and other interface elements described herein.

Moreover, as used herein, the term “content item” or “digital content” refers to a digital object or a digital file that includes information interpretable by a computing device (e.g., a client device) to present information to a user. A content item can include a file such as a digital text file, a digital image file, a digital audio file, a webpage, a website, a digital video file, a web file, a link, a digital document file, or some other type of file or digital object. A content item can have a particular file type or file format, which may differ for different types of digital content items (e.g., digital documents. digital images, digital videos, or digital audio files). In some cases, a content item can refer to a remotely stored (e.g., cloud-based) item or a link (e.g., a link to a cloud-based item or a web-based content item) and/or a content clip that indicates (or links) a discrete selection or segmented portion of content from a webpage or some other content item or source. A content item can be editable or otherwise modifiable and can also be sharable from one user account (or client device) to another. In some cases, a content item is modifiable by multiple user accounts (or client devices) simultaneously and/or at different times.

In addition, as used herein, the term “virtual meeting” refers to a digital or online gathering where participants connect and communicate using various digital tools. Specifically, during a virtual meeting client devices connect through various digital tools through video, audio, text, or some combination thereof. In some cases, a virtual meeting includes communication in real-time, where client devices participating in the virtual meeting can send and receive video, audio and/or text as participants of the virtual meeting provide user input. In addition, during a virtual meeting client devices can also send or receive files, share screens, or chat (e.g., in a chat application of a virtual meeting interface). A virtual meeting an include a video call, an audio call, a chat using a chat-based platform, or other suitable digital interaction.

Relatedly, the term “video call” refers to a real-time communication method that allows participants in different locations to interact visually and audibly using video and audio streams. In particular, client devices utilize a digital platform to send and receive data corresponding to the video call and that allows participants to see and hear each other and interact in real time.

Further, as used herein, the term “meeting data” refers to the information captured during a video call or virtual meeting. Specifically, the term meeting data can include information that captures the content of discussions, decisions made, actions assigned, and other interactions or outcomes from the meeting (e.g., as generated by a large language model). Meeting data can also include the metadata, timestamps, device data, or other data or information gathered from computing devices associated with the meeting. Meeting data can include transcripts, minutes, notes, audio or video recordings, or other relevant documentation. Meeting data can be generated simultaneously with the meeting, such as through the use of recording devices or transcription services that process meeting data during the interaction of the meeting. Similarly, as used herein, the term “transcript” refers to a digitized text version of data captured during a phone call or a video call. In particular, a transcript can include the words spoken by each participant in the discussion, phone call, or video call. To illustrate, a transcript of a video call can be a digital document that comprises the text and metadata associated with the video call.

Furthermore, as used herein, the term “large language model” (LLM) refers to one or more machine learning model trained to perform computer tasks to generate or identify content items in response to trigger events (e.g., user interactions, such as text queries and button selections). In particular, a large language model can be a neural network (e.g., a deep neural network or a transformer neural network) with many parameters trained on large quantities of data (e.g., unlabeled text) using a particular learning technique (e.g., self-supervised learning). For example, a large language model can include parameters trained to generate outputs (e.g., block content elements) based on prompts and/or to identify content items based on various contextual data, including graph information from a knowledge graph and/or historical user account behavior. In some cases, a large language model comprises a GPT model such as, but not limited to, ChatGPT.

As used herein, the term “machine learning model” refers to a computer algorithm or a collection of computer algorithms that automatically improve for a particular task through iterative outputs or predictions based on the use of data. For example, a machine learning model can utilize one or more learning techniques to improve accuracy and/or effectiveness. For example, machine learning models include various types of neural networks, decision trees, support vector machines, linear regression models, and Bayesian networks. In some embodiments, the morphing interface system utilizes a large language machine-learning model in the form of a neural network.

Relatedly, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., block content elements or content items) based on a plurality of inputs provided to the neural network. In some cases, a neural network refers to an algorithm (or set of algorithms) that implements deep learning techniques to model high-level abstractions in data. A neural network can include various layers, such as an input layer, one or more hidden layers, and an output layer, each of which performs tasks for processing data. For example, a neural network can include a deep neural network, a convolutional neural network, a transformer neural network, a recurrent neural network (e.g., an LSTM), a graph neural network, or a generative adversarial neural network. Upon training, such a neural network may become a large language model.

In addition, as used herein, the term “transcript analysis interface” refers to an interface for a system that generates, analyzes, and/or provides output for video calls. Specifically, the term “transcript analysis interface” refers to an interface of a smart topic generation system that provides specialized, intelligent tools for interacting with transcripts and/or content from video calls. For example, a transcript analysis interface can receive user input that prompts a smart topic generation system to generate smart topics or provides options to generate virtual spaces using transcripts or other meeting data from video calls associated with the transcript analysis interface.

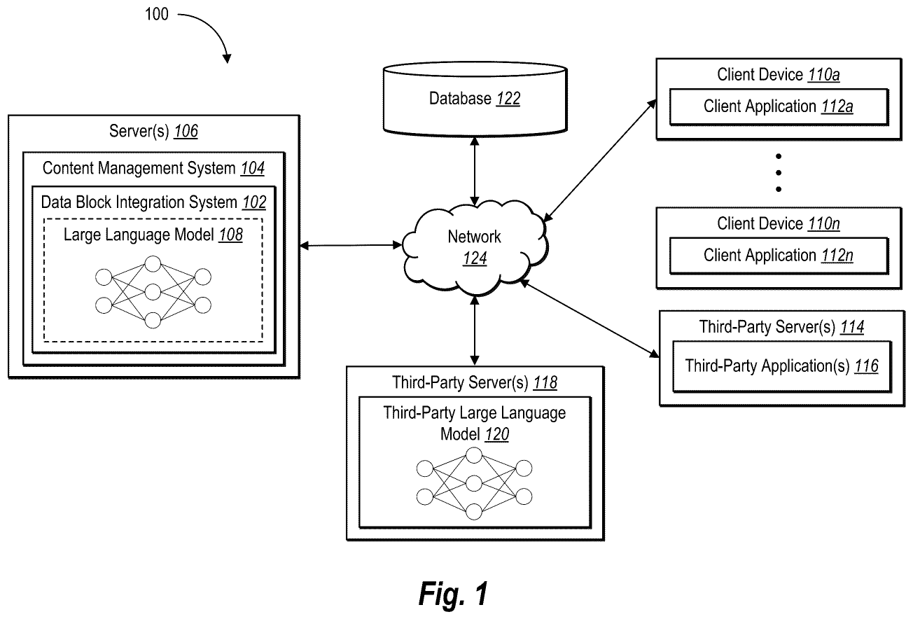

Additional details regarding the data block integration system will now be provided with respect to the figures. For example, FIG. 1 illustrates a block diagram of a system environment for implementing the data block integration system in accordance with one or more embodiments. An overview of the data block integration system is described in relation to FIG. 1. Thereafter, a more detailed description of the components and processes of the data block integration system 102 is provided in relation to the subsequent figures.

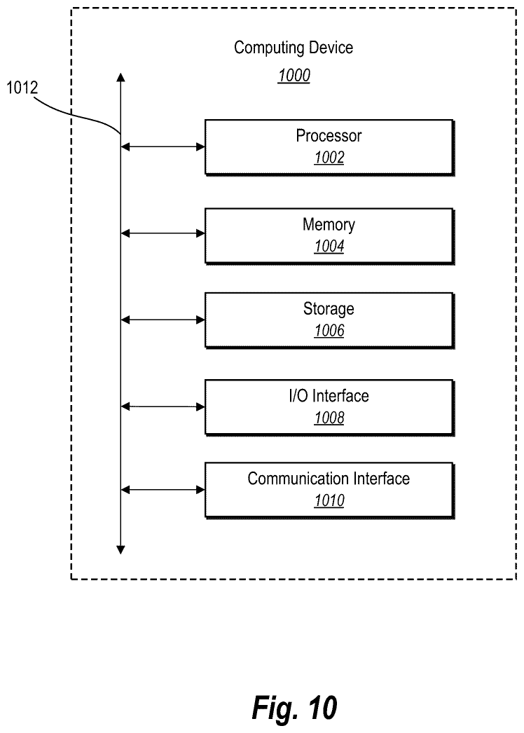

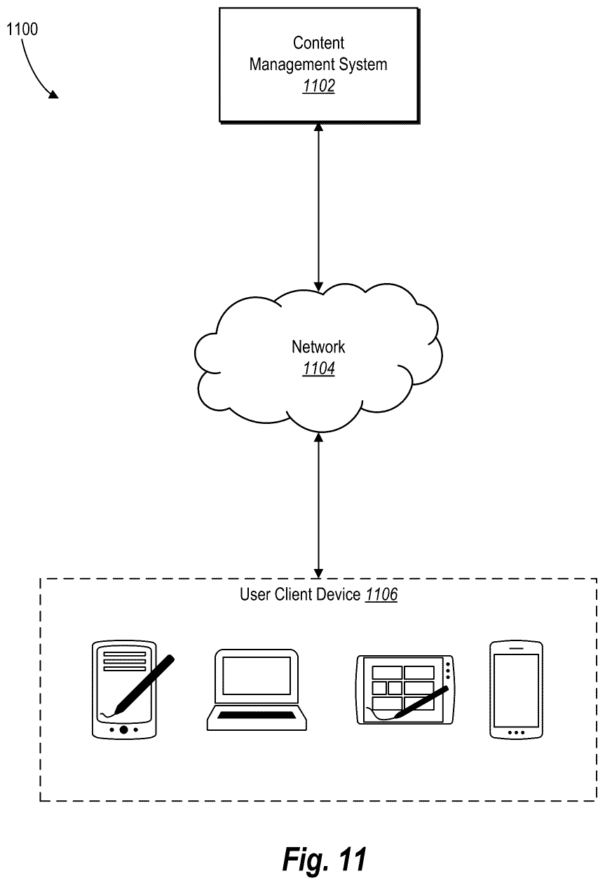

As shown, the environment 100 includes server(s) 106, database 122, client device(s) 110a-110n, third-party server(s) 114, and third-party server(s) 118. Each of the components of the environment 100 can communicate via network 124, and network 124 may be any suitable network over which computing devices can communicate. Example networks are discussed in more detail in relation to FIGS. 10-11.

As mentioned above, the environment 100 includes client device(s) 110a-110n. The client device(s) 110a-110n can be one of a variety of computing devices, including a smartphone, a tablet, a smart television, a desktop computer, a laptop computer, a virtual reality device, an augmented reality device, or another computing device as described in relation to FIGS. 10-11. The client device(s) 110a-110n can communicate with the server(s) 106 via network 124. For example, the client device(s) 110a-110n can receive user input from a user interacting with client device(s) 110a-110n (e.g., via the client application(s) 112a-112n) to, for instance, participate in a video call, select user interface elements to interact with the content management system, or to interact with data blocks in a virtual space. In addition, the data block integration system 102 or the server(s) 106 can receive information relating to various interactions with content items and/or user interface elements based on the input received by the client device(s) 110a-110n.

As shown, the client device(s) 110a-110n can include a client application 112a-112n. In particular, the client application 112a-112n may be a web application, a native application installed on the client device(s) 110a-110n (e.g., a mobile application, a desktop application, etc.), or a cloud-based application where all or part of the functionality is performed by the server(s) 106. Based on instructions from the client application(s) 112a-112n, the client device(s) 110a-110n can present or display information, including a user interface for interacting with (or collaborating regarding) generating data blocks in virtual spaces using meeting data. Using the client application(s) 112a-112n, the client device(s) 110a-110n can perform (or request to perform) various operations, such as generating block content elements for a data block utilizing meeting data from multiple video calls.

As illustrated in FIG. 1, the environment 100 also includes the server(s) 106. The server(s) 106 may generate, track, store, process, receive, and transmit electronic data, such as meeting data, block content elements, results, actions, determinations, responses, computer code specific to data blocks or virtual spaces, interactions with interface elements, and/or interactions between user accounts or client devices. For example, the server(s) 106 may receive an indication from the client device(s) 110a-110n of a user interaction selecting an option to generate a virtual space, an option to add a data block to a virtual space, or a prompt to generate a specific output for a data block. In addition, the server(s) 106 can transmit data to the client device(s) 110a-110n in the form of a block content element, an instruction to render a data block, or an instruction to render a virtual space. Indeed, the server(s) 106 can communicate with the client device(s) 110a-110n to send and/or receive data via network 124. In some implementations, the server(s) 106 comprise(s) a distributed server where the server(s) 106 include(s) a number of server devices distributed across the network 124 and located in different physical locations. The server(s) 106 can comprise one or more content servers, application servers, container orchestration servers, communication servers, web-hosting servers, machine learning servers, and other types of servers.

As shown in FIG. 1, the server(s) 106 can also include the data block integration system 102 as part of the content management system 104. The content management system 104 can communicate with the client device(s) 110a-110n to perform various functions associated with the client application(s) 110a-110n, such as managing user accounts, defining virtual spaces, and/or identifying content items. Indeed, content management system 104 can include a network-based smart cloud storage system to manage, store, and maintain content items and related data across numerous user accounts. In some embodiments, the data block integration system 102 and/or the content management system 104 utilize the database 122 to store and access information such as content items, video call transcript data, data blocks, and other information.

As also illustrated, in one or more embodiments, the environment 100 includes the third-party server(s) 114 that hosts third-party application(s) 116. Specifically, the third-party application(s) communicate with server(s) 106, the client device(s) 110a-110n, and/or the database 122 to provide third-party data corresponding to generating block content elements. For example, the data block integration system 102 provides the third-party data from third-party application(s) 116 to the large language model for generating block content elements. In some instances, the data block integration system 102 receives third-party data based on a connection between the third-party application(s) 116 and the virtual space (e.g., an API connection or via a connector).

As further illustrated, in one or more embodiments, the environment 100 includes the third-party server(s) 118 that hosts the third-party large language model 120. In particular, the third-party large language model 120 communicates with the server(s) 106, the client device(s) 110a-110n, and/or the database 122. For example, the data block integration system 102 provides domain-specific language segments to the third-party large language model 120, where the domain-specific language segments indicate meeting data for generating block content elements. Indeed, the third-party large language model 120 can include a machine learning model powered by neural networks or other machine learning architectures for generating responses to text queries. For instance, the third-party large language model 120 can refer to a ChatGPT model or a large language model that generates computer-executable code segments for generating block content elements.

As also illustrated, in one or more embodiments, the data block integration system 102 hosts a large language model 108. In particular, the content management system 104 and/or the data block integration system 102 host large language model 108 within a firewall of the content management system 104 and/or data block integration system 102. This way, during meetings with sensitive data, the data block integration system 102 does not need to privatize data and can access content items comprising sensitive data. In addition, in some cases, the data block integration system utilizes a combination of the large language model 108 and the third-party large language model 120. For example, the data block integration system 102 can utilize the third-party large language model 120 based on the availability of the large language model 108 (e.g., when large language model 108 is busy or otherwise unavailable).

Although FIG. 1 depicts the data block integration system 102 located on the server(s) 106, in some implementations, the data block integration system 102 may be implemented by (e.g., located entirely or in part on) one or more other components of the environment. For example, the data block integration system 102 may be implemented as part of client device(s) 110a-110n and/or a third-party system. As another example, the client device(s) 110a-110n and/or a third-party system can download all or part of the data block integration system 102 for implementation independent of, or together with, the server(s) 106.

In some implementations, though not illustrated in FIG. 1, the environment 100 may have a different arrangement of components and/or may have a different number or set of components altogether. For example, the client device(s) 110a-110n may communicate directly with the data block integration system 102, bypassing network 124. The environment 100 may also include one or more third-party systems, each corresponding to a different data source. In addition, the environment 100 can include the database 122 located external to the server(s) 106 (e.g., in communication via the network 124) or located on the server(s) 106 and/or on the client device(s) 110a-110n. In some cases, the server(s) 106 and/or the client device(s) 110a-110n can host or house all or part of the third-party large language model 120.

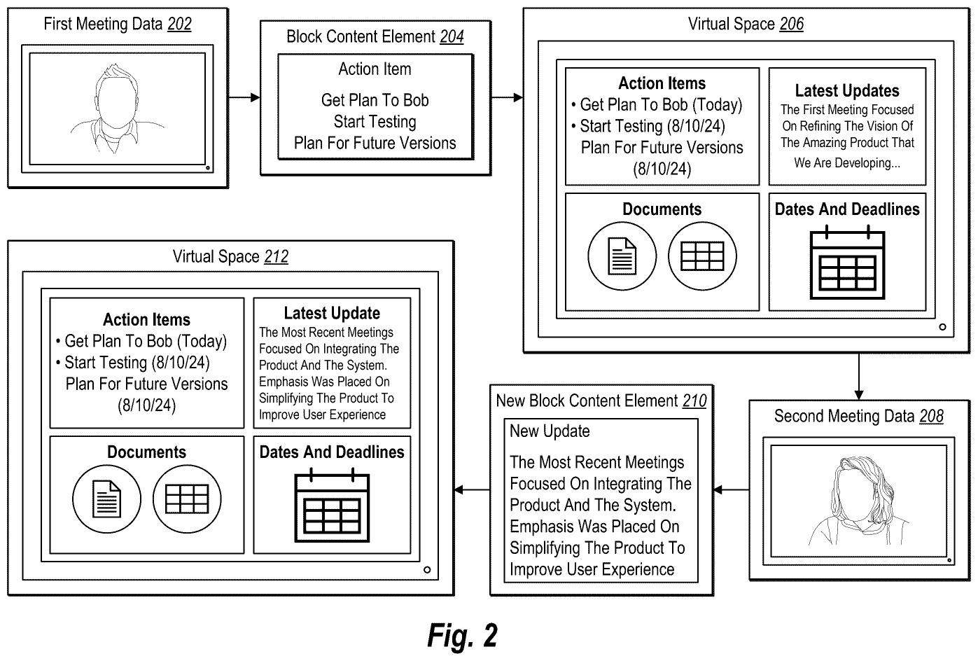

As mentioned, the data block integration system 102 generates a virtual space tied to multiple video calls. In particular, the data block integration system 102 generates a block content element for a data block in a virtual space using meeting data of a first video call, then generates a new block content element utilizing meeting data from a second video call. FIG. 2 illustrates an example diagram of an overview of generating block content elements associated with multiple video calls in accordance with one or more embodiments. Additional detail regarding the various acts and processes introduced in relation to FIG. 2 is provided thereafter with reference to subsequent figures.

As illustrated in FIG. 2, the data block integration system 102 generates or obtains first meeting data 202 from a first video call. In particular, the data block integration system 102 generates or receives first meeting data captured during and/or extracted from the first video call. For example, the data block integration system 102 generates a transcript of the first video call and/or topic-specific (or block-type specific) text strings extracted from a transcript. In some cases, the data block integration system 102 receives first meeting data from a first virtual meeting.

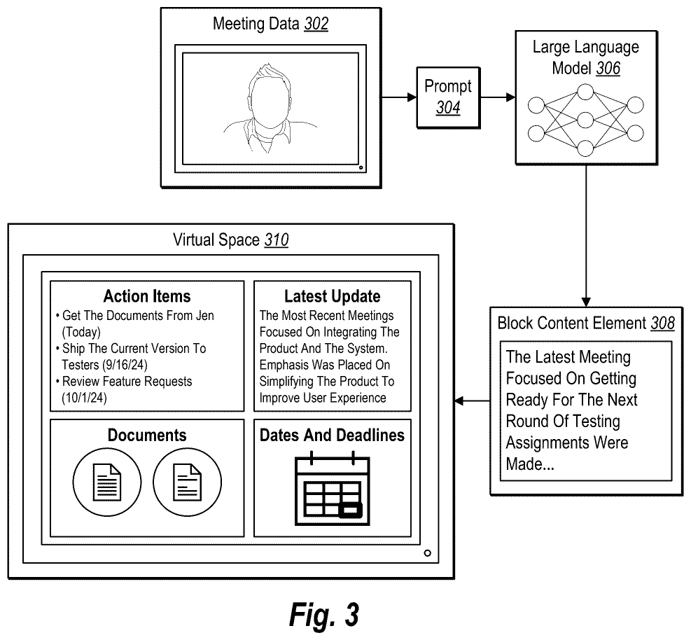

As also shown, the data block integration system 102 generates a block content element 204 from the first meeting data 202. Specifically, the data block integration system 102 utilizes a large language model to generate block content element 204 corresponding to a block type of a data block. As part of this process, the data block integration system 102 receives or generates a prompt for the large language model to generate block content element 204 from the first meeting data 202. From the prompt, the large language model generates a block content element that incorporates the first meeting data 202 in a format defined by a block type of a destination data block where the block content element is to be added. Additional details regarding the data block integration system 102 providing a prompt to a large language model to generate a block content element are provided below with respect to FIG. 3.

As shown, the data block integration system 102 adds the block content element to a data block of virtual space 206. Specifically, the data block integration system 102 adds the block content element 204 to a data block embedded in virtual space 206. In some embodiments, the data block integration system 102 adds a block content element to a multilocational data block as described in U.S. application Ser. No. 18/193,097 entitled GENERATING AND MANAGING MULTILOCATIONAL DATA BLOCKS, filed on Mar. 30, 2023, which is hereby incorporated by reference in its entirety.

In one or more embodiments, the data block integration system 102 provides various entry points to access virtual space 206 and generate or modify data blocks within virtual space 206. For instance, the data block integration system 102 generates virtual space 206 and/or generates block content element 204 to add to a data block in response to user interaction. Specifically, the data block integration system 102 receives a selection of an option to generate virtual space 206 and generates block content element 204 for a data block to embed within virtual space 206. For example, the data block integration system 102 generates an option (e.g., in an interface or in a prompt) to generate virtual space 206 associated with first meeting data 202 and generates one or more block content elements based on receiving a selection of the option.

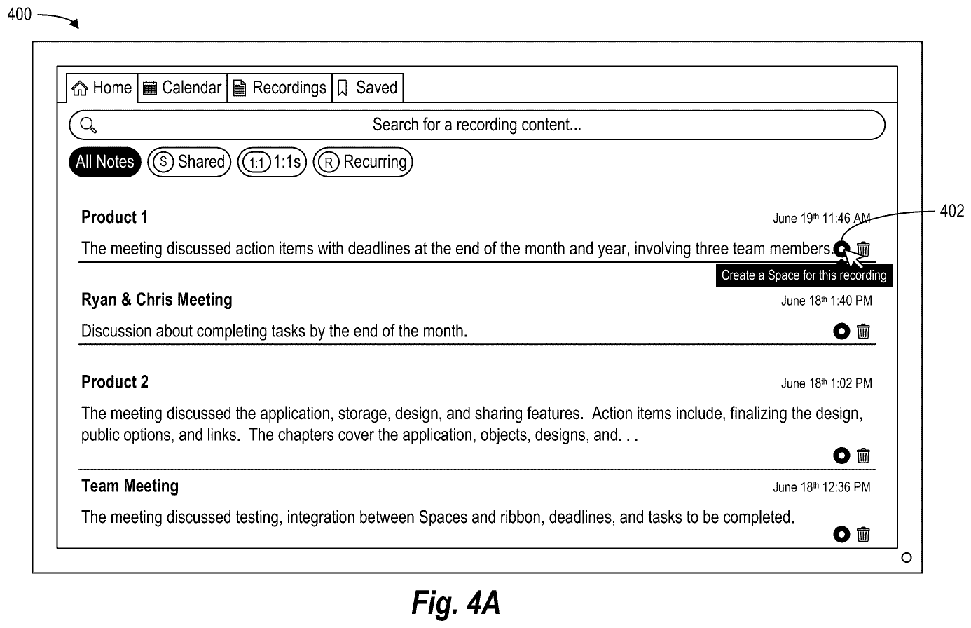

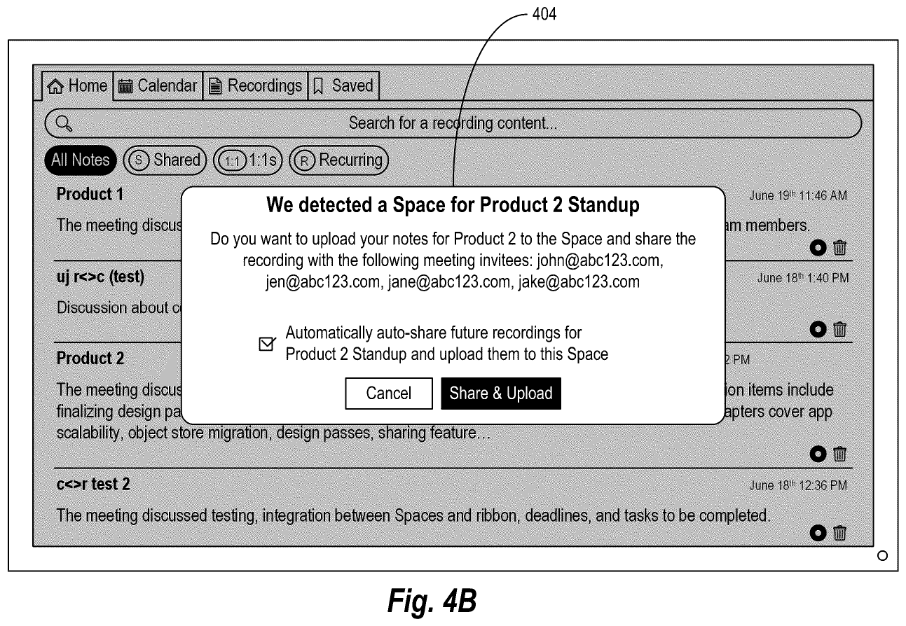

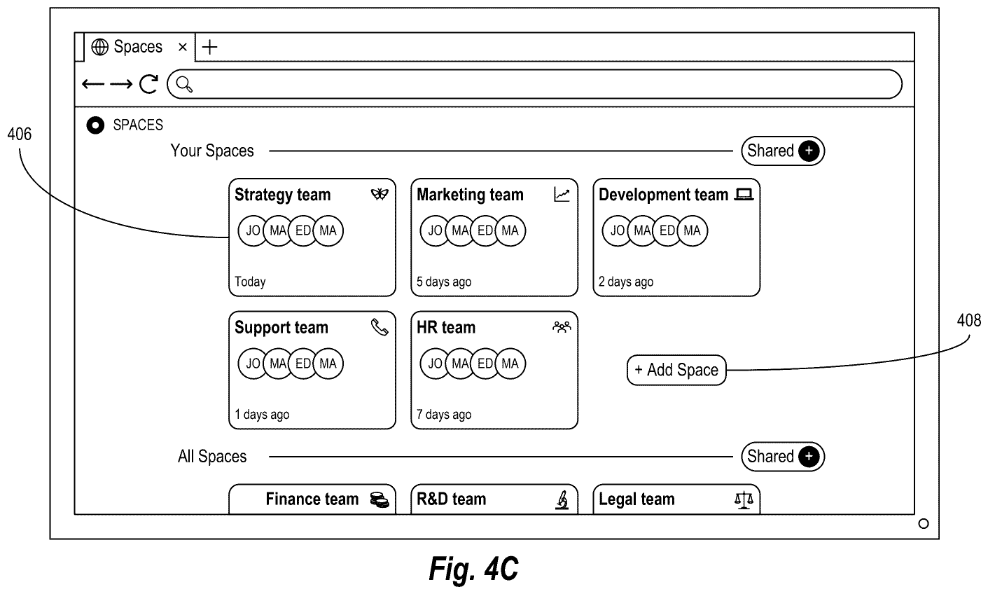

In one or more embodiments, the data block integration system 102 receives a selection of an option to generate a virtual space within a transcript analysis interface. A transcript analysis interface can refer to one or more interfaces associated with a smart topic generation system as described in U.S. application Ser. No. 18/470,885, filed Sep. 20, 2023, entitled GENERATING SMART TOPICS FOR VIDEO CALLS USING A LARGE LANGUAGE MODEL AND A CONTEXT TRANSFORMER ENGINE, filed on Sep. 20, 2023, which is hereby incorporated by reference in its entirety. In addition, a transcript analysis interface can refer to one or more interfaces associated with a meeting insight system as described in U.S. application Ser. No. 18/414,996 entitled GENERATING INTELLIGENT MEETING INSIGHTS FOR UPCOMING VIDEO CALLS, filed on Jan. 17, 2024, which is incorporated by reference in its entirety. Additional details regarding the data block integration system 102 generating a virtual space based on receiving a selection of an option within a transcript analysis interface are provided below with respect to FIGS. 4A-4B.

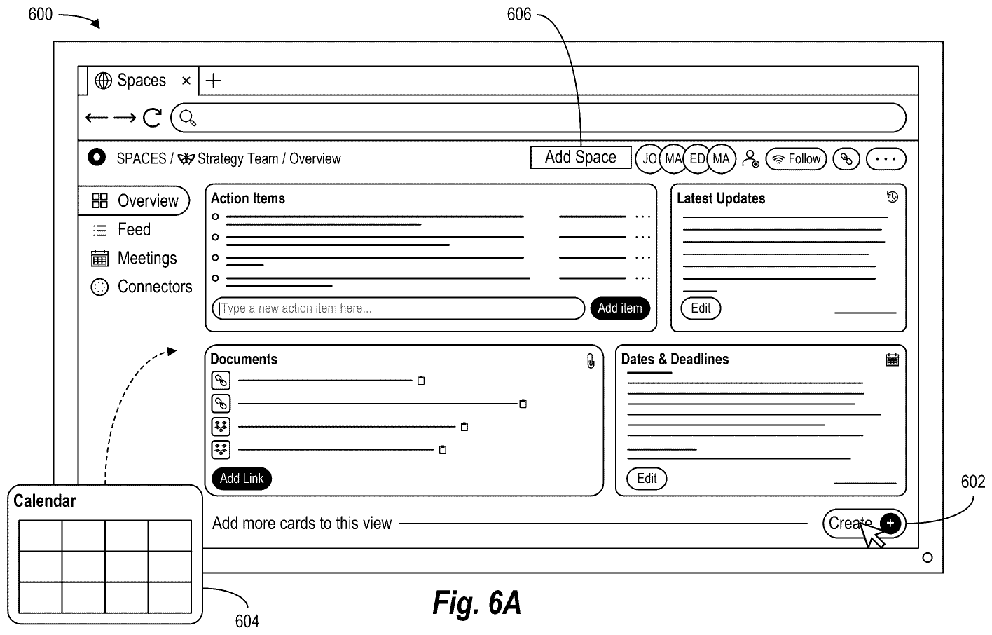

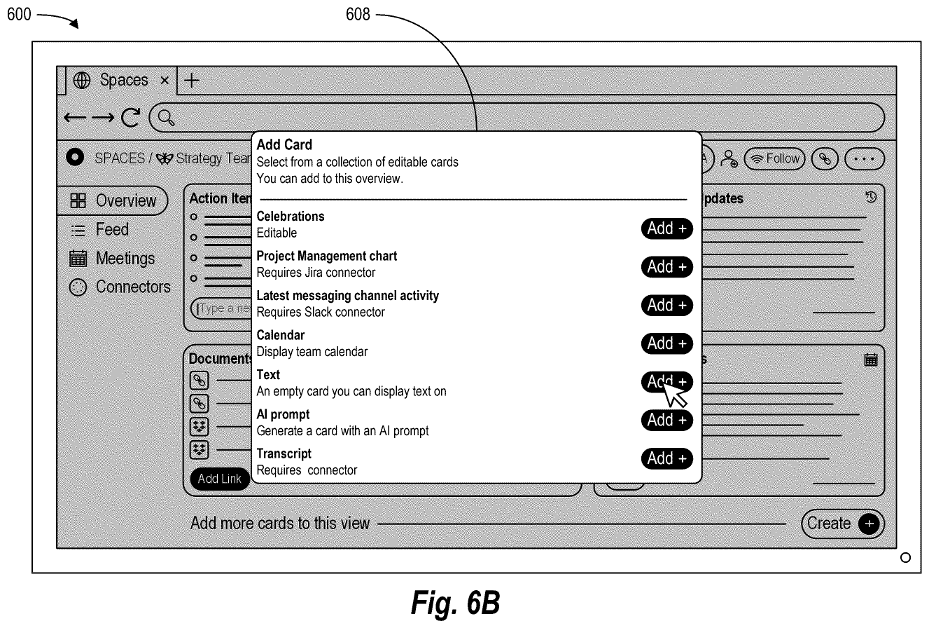

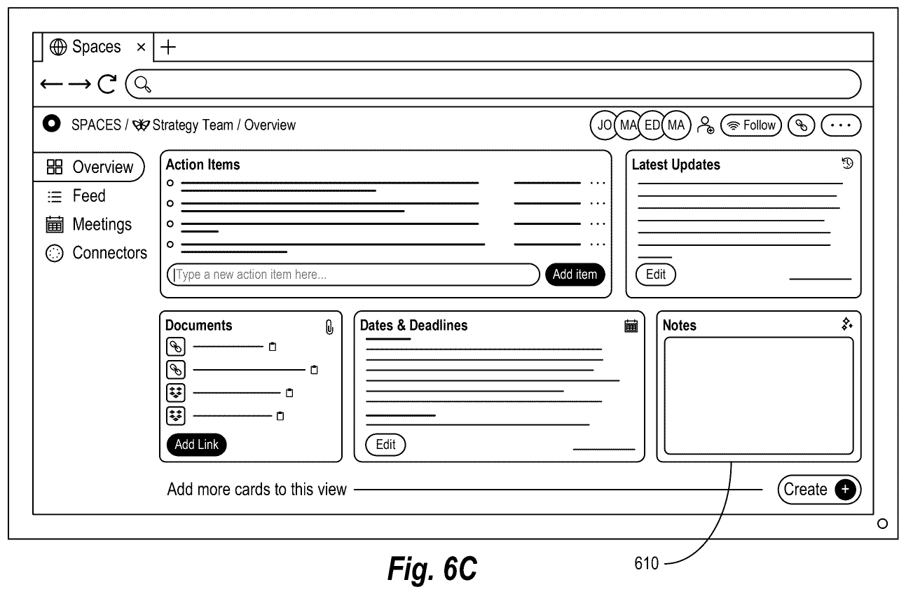

In one or more embodiments, the data block integration system 102 generates the virtual space 206 by generating block content elements for specific data block types. Specifically, the data block integration system 102 generates a summary of meeting data for an update block, extracts action items from meeting data for an action item block, identifies documents mentioned in the meeting data, generates document elements for a document block, and identifies deadlines with corresponding dates for a dates block. In addition to generating specific blocks for the virtual space 206, the data block integration system 102 can generate additional information connected to the virtual space 206, such as a detailed feed of recent data associated with the virtual space 206, meetings associated with the virtual space 206, and third-party connectors to the virtual space 206. Additional details regarding the data block integration system 102 generating specific data blocks and generating additional information connected to the virtual space 206 are provided below with respect to FIGS. 6A-6C.

In addition, in one or more embodiments, the data block integration system 102 adds block content element 204 to a data block in the virtual space 206. Specifically, the data block integration system 102 analyzes the first meeting data 202 and determines that the first meeting data is associated with the virtual space 206. The data block integration system 102 thus adds the block content element to an existing data block in the virtual space 206. In some instances, the data block integration system 102 replaces a block content element in the virtual space 206 with block content element 204. In other instances, the data block integration system 102 generates a new data block and adds the new data block with block content element 204 to the virtual space 206. Additional details regarding the data block integration system 102 generating block content elements to add an existing virtual space are discussed further below with respect to FIG. 3 below.

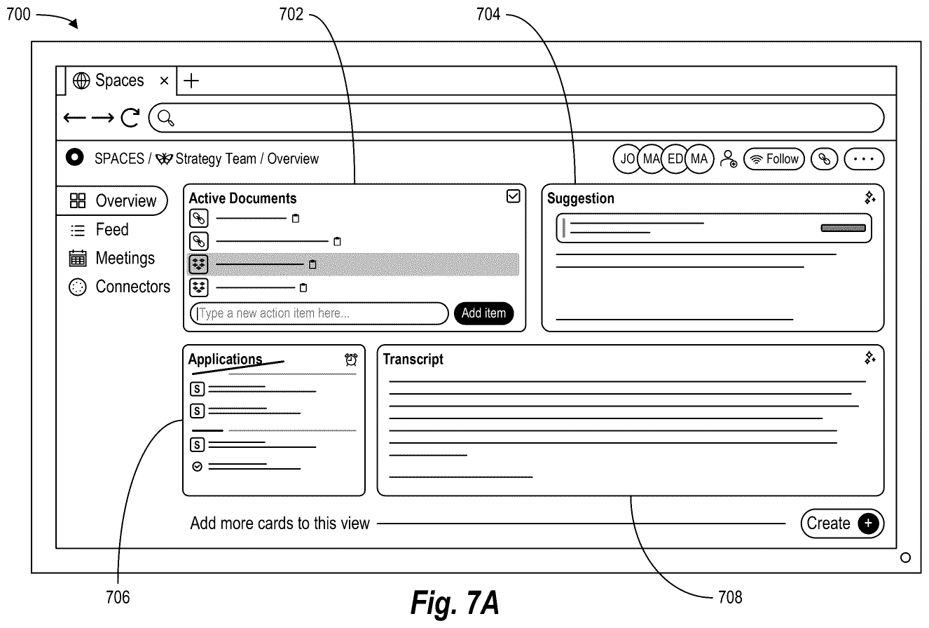

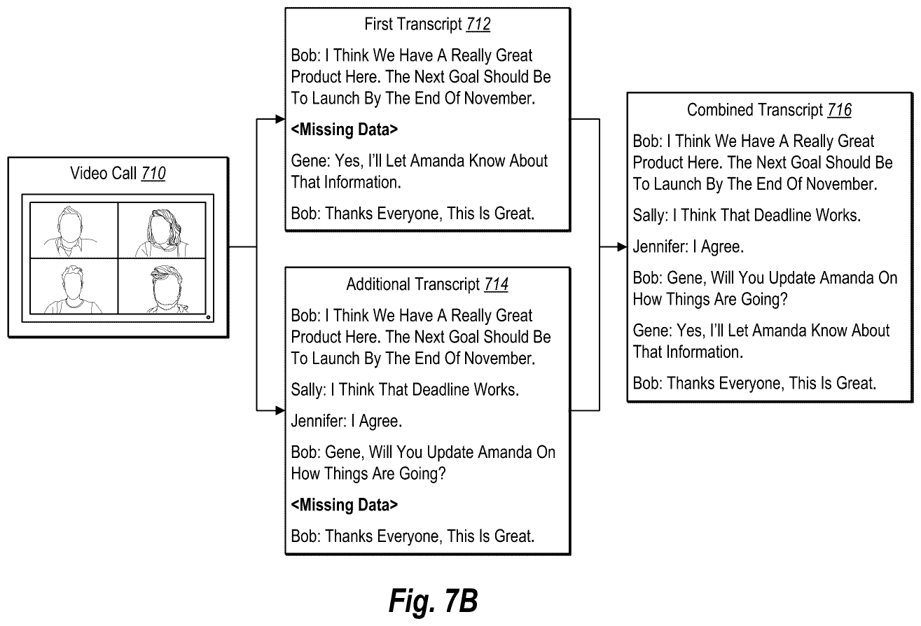

In one or more embodiments, the data block integration system 102 adds data blocks to the virtual space 206 based on receiving a request to generate a data block from a client device. Specifically, the data block integration system 102 generates block content elements and adds data blocks corresponding to the request to generate the data block. Additional information regarding the data block integration system 102 adding data blocks to a virtual space based on receiving a request to generate a data block from a client device is provided below with respect to FIGS. 7A-7B.

As further illustrated in FIG. 2, the data block integration system 102 receives (or generates) second meeting data 208 associated with a second video call (or second virtual meeting) and generates new block content element 210. Specifically, the data block integration system 102 generates the new block content element 210 to update a data block within the virtual space 212 (e.g., an updated version of the virtual space 206). For example, the data block integration system 102 identifies that the second video call is associated with the virtual space 206 and generates the new block content element 210 to update virtual space 206 (e.g., to generate virtual space 212). In some cases, the data block integration system 102 determines that the second meeting data 208 is associated with the first meeting data 202 and generates the new block content element 210 to update the virtual space 206 with information and/or data from the second video call. As mentioned, the data block integration system 102 generates new block content element 210 to update virtual space 212. In particular, the data block integration system generates the block content element 210 that includes information from the first meeting data 202 and the second meeting data 208 to generate the block content element 210 based on receiving (or generating) second meeting data 208. For example, based on receiving the second meeting data 208, the data block integration system 102 generates new block content element 210 by generating a summary of a first video call associated with first meeting data 202 and a second video call associated with second meeting data 208 for the update block of the virtual space 206 (thus, generating virtual space 212).

As previously mentioned, the data block integration system 102 generates the block content element 210 based on determining a corresponding block type of an existing data block in the virtual space 206. For example, the data block integration system 102 can add a transcript data block that provides a transcript from a video call associated with the virtual space 206, an application block that displays third-party data from connected third-party applications, or suggested blocks comprising suggested content based on analyzing meeting data (e.g., from multiple video calls). In addition, in instances where the data block integration system 102 generates block content elements for a transcript block, the data block integration system 102 can generate a combined transcript from multiple video calls. Additional details regarding additional block types to add to a virtual space and generating a combined transcript are provided below with respect to FIGS. 7A-7B.

Also, as previously mentioned, the data block integration system 102 determines that video calls are associated with the virtual space 206. The data block integration system 102 can thus receive user input to add (or connect) a new video call to the virtual space 206 and can generate the block content element 210 based on adding the video call to the virtual space 206. For example, the data block integration system 102 can update the virtual space 206 based on a past video call or update the virtual space 206 during (and after) an upcoming video call. Additional details regarding the data block integration system 102 adding a video call to a virtual space are provided below with respect to FIGS. 4A-4C below.

In addition, as previously mentioned, in some embodiments, the data block integration system 102 utilizes a large language model to generate a block content element for a data block of a virtual space. In particular, the data block integration system 102 can provide a prompt to a large language model to generate a block content element according to block content specifications. FIG. 3 illustrates a schematic diagram of a data block integration system utilizing a large language model to generate a block content element in accordance with one or more embodiments.

As shown, the data block integration system 102 receives meeting data 302. Specifically, the data block integration system 102 receives meeting data 302 that includes a transcript from a video call and/or data extracted from the transcript, including topics, timestamps when the topics were discussed, shared content items (and their timestamps), network and/or technical data, and/or speaker identification information. In some embodiments, the data block integration system 102 captures video and/or audio data from one or more client devices participating in a video call and generates the meeting data 302 from the captured video and audio data. For example, the data block integration system 102 can utilize a transcription model to convert audio data from a video call to digitized text. As another example, the data block integration system 102 transcribes audio data (e.g., words and other language components spoken by participants) in a video call into a transcript. In some cases, the data block integration system 102 identifies when a client device begins a video call (e.g., through the initiation of a video call application or interface) and generates a transcript upon initialization of the video call.

In addition, in one or more embodiments, in addition to (or instead of) receiving the meeting data 302, the data block integration system 102 can also receive third-party application data. Specifically, the data block integration system 102 receives third-party data from third-party applications associated with the virtual space. The data block integration system 102 can connect to third-party applications to receive third-party data in a format suitable for generating block content elements. In some cases, the data block integration system 102 connects to a third-party application through an application programming interface that provides data and information to the data block integration system 102. In other cases, the data block integration system 102 utilizes a webhook to receive updates from a third-party application (e.g., when updates are available). In even more cases, the data block integration system 102 connects to a third-party application through a sync coordination system as described in U.S. application Ser. No. 18/776,830, entitled DATA INGESTION UTILIZING A COORDINATOR AND CONNECTORS, filed on Jul. 18, 2024, which is hereby incorporated by reference in its entirety.

As also shown, the data block integration system 102 generates a prompt 304 for large language model 306 to generate block content element 308. In particular, the data block integration system 102 generates a prompt 304 that utilizes meeting data 302 and provides instructions for large language model 306 for generating block content element 308. For example, the data block integration system 102 includes meeting data 302 (and/or third-party application data) in the prompt, along with instructions to summarize the meeting data 302. In some cases, the data block integration system 102 generates the prompt 304 in a block-type-specific format, instructing the large language model 306 to extract and summarize data (for the block content element 308) specific to a block type (e.g., “identify and summarize any action items mentioned in the meeting” or “generate a list of dates and corresponding events for the dates mentioned in the meeting”). In such cases, the data block integration system 102 thus generates a different prompt for each block type, identifying, extracting, and summarizing content for each type.

In one or more embodiments, prompt 304 includes instructions for large language model 306 to generate the block content element 308 based on block content specifications. Specifically, prompt 304 can include specifications, guidelines, or parameters that instruct large language model 306 on what content to extract from meeting data 302 to generate the block content element 308. For example, prompt 304 might specify specific points or keywords, style, length, formatting guidelines, or constraints. To illustrate, block content specifications can include how descriptive the block content element 308 should be, the objective, main ideas or key points, format (e.g., bullet points or plain text), whether to include headings or subheadings (e.g., how to break down sections), exclusions, granularity, word character limits.

In one or more embodiments, the data block integration system 102 generates block content element 308 based on comparing extracted data from extracted data from meeting data 302 to existing block content elements. Specifically, the data block integration system 102 utilizes large language model 306 to determines a delta (or difference) between the extracted data from meeting data 302 and the existing block content elements. Based on the delta, the large language model 306 generates a new block content element based on the block type of that incorporates the delta while also incorporating information from the previous block content element. For example, as shown in FIG. 3, the large language model 306 can identify a delta difference in the overall content of multiple video calls (or a certain number of most recent video calls) and generate a summary that includes information from the video calls.

As shown, the data block integration system 102 then updates virtual space 310 with block content element 308. In particular, the data block integration system 102 updates virtual space 310 by adding block content element 308 to a data block embedded within virtual space 310 (e.g., the Latest Update block). In one or more embodiments, the data block integration system 102 adds the block content element 308 to an existing data block within virtual space 310. The data block integration system 102 adds the block content element 308 to a data block of the same block type as determined for the block content element 308. For example, as shown, block content element 308 is a summary block content element for an update block, so the data block integration system 102 adds block content element 308 to the updates block in virtual space 310. Indeed, the data block integration system 102 does not require user input to update data blocks of the virtual space 310 but intelligently and automatically updates virtual space 310 upon receiving meeting data, so the virtual space 310 is a dynamic and consistently updated communal space that is updated with new data from meetings, third-party applications, and content changes.

In addition to updating the virtual space 310, the data block integration system 102 can also generate a new virtual space and add the block content element to a data block within the new virtual space. Specifically, in response to receiving a request to generate a virtual space, the data block integration system 102 generates one or more block content elements to add to data blocks and generate the new virtual space. In some cases, to generate a virtual space, the data block integration system 102 generates a set of block content elements corresponding to a standard set of data blocks for new virtual spaces. In some cases, as a default (and modifiable) set of initial blocks, when generating block content elements for a new virtual space, the data block integration system 102 generates block content elements for each of an update block, a documents block, a dates and deadlines block, and an action item block.

The data block integration system 102 can also generate and add a block content element to a new data block. In particular, the data block integration system 102 can receive a request to generate an additional data block in the virtual space and generate the block content element for the additional data block. For example, the data block integration system 102 can receive a request to generate a data block of a specific block type and can generate block content element 308 according to the block content specifications of the block type. To illustrate, if the data block integration system 102 receives a request to generate an update block, the data block integration system 102 will generate a block content element corresponding to block content specifications for an update block.

The data block integration system 102 can also generate block content elements at varying times with respect to a video call. For example, in one or more embodiments, the data block integration system 102 generates prompt 304 at the conclusion of a video call or at some time after completion of the video call when the data block integration system 102 can receive a complete instance of meeting data. The data block integration system 102 then utilizes the meeting data 302 reflecting the whole video call to generate the block content element 308 for a data block of the virtual space 310. For example, the data block integration system 102 can utilize a transcript reflecting discussions from throughout the meeting within a prompt and generate one or more block content elements for the virtual space 310 using the transcript.

In some embodiments, the data block integration system 102 generates block content elements during a video call. Specifically, the data block integration system 102 provides prompts with portions of meeting data throughout the video call, generating block content elements to update data blocks within the virtual space 310 during the video call. For example, the data block integration system 102 can generate prompts at certain intervals throughout the video call, where the prompts comprise portions of the meeting data 302 for a certain period of time (e.g., 1 minute, 5 minutes). To illustrate, the data block integration system 102 can provide meeting data 302 from the previous two minutes of a video call and instruct the large language model 306 to extract action items from the meeting data for an action item block.

In addition, in one or more embodiments, the data block integration system 102 adds a content block to the virtual space 310 based on identifying that the video call is associated with the virtual space 310. Specifically, the data block integration system 102 analyzes meeting data 302 and identifies that the video call is associated with the virtual space 310. For example, the data block integration system 102 can determine that the meeting data 302 comprises content similar to other meeting data already in the virtual space 310, such as by using the large language model 306 to analyze and compare the meeting data 302 (e.g., by extracting and determining distances between topic embeddings of the meeting datasets). As another example, the data block integration system 102 can determine that user accounts who attended the virtual calls are associated with the virtual space 310.

As previously mentioned, the data block integration system 102 can generate a virtual space utilizing meeting data. In particular, the data block integration system 102 can generate virtual spaces and can add meeting data to the virtual spaces from a transcript analysis system or from the data block integration system 102. FIGS. 4A-4C illustrate example graphical user interfaces of options for adding meeting data to a virtual space from a transcript analysis system in accordance with one or more embodiments. In particular, FIG. 4A illustrates an example graphical user interface of the data block integration system 102 receiving a user selection of an option to generate a virtual space from a transcript analysis system. FIG. 4B illustrates an example graphical user interface of the data block integration system 102 providing a prompt within a transcript analysis system to add meeting data to a virtual space. FIG. 4C illustrates an example graphical interface of virtual spaces associated with a user and an option to add an additional virtual space.

As shown in FIG. 4A, the data block integration system 102 generates a virtual space from a transcript analysis interface 400 based on receiving a selection of option 402. In one or more embodiments, the transcript analysis interface 400 is associated with a smart topic generation system that generates smart topic output from meeting data, including summaries of discussions from video calls. In some cases, a smart topic generation system refers to a smart topic generation system as described in U.S. application Ser. No. 18/470,885, filed Sep. 20, 2023, entitled GENERATING SMART TOPICS FOR VIDEO CALLS USING A LARGE LANGUAGE MODEL AND A CONTEXT TRANSFORMER ENGINE, filed on Sep. 20, 2023, which is hereby incorporated by reference in its entirety. In addition, a smart topic generation system can refer to a meeting insight system as described in U.S. application Ser. No. 18/414,996 entitled GENERATING INTELLIGENT MEETING INSIGHTS FOR UPCOMING VIDEO CALLS, filed on Jan. 17, 2024, which is incorporated by reference in its entirety.

As shown, the transcript analysis interface can provide a smart topic output corresponding to video calls along with option 402 to generate a virtual space corresponding to the video call. Based on a user selection of option 402, the data block integration system 102 utilizes meeting data associated with the video call to generate a virtual space. As part of generating a virtual space, the data block integration system 102 can generate the space to include a default initial set of virtual data blocks, including an update block an action item block, a document block (or a content item block), and a dates block. In some cases, the default set is modifiable to include additional or alternative block types.

In one or more embodiments, when the meeting data is associated with multiple video calls, the data block integration system 102 generates the virtual space using multiple instances of meeting data. For example, for a recurring video call that has several instances of meeting data, the data block integration system 102 can access or receive multiple instances of meeting data and utilize that meeting data to generate block content elements for the virtual space. In some cases, the data block integration system 102 accesses a limited number of instances of previous meeting data from previous video calls (e.g., meeting data from the previous three meetings).

In addition, in some embodiments, upon receiving a selection of option 402 to generate a virtual space, the data block integration system 102 determines that there is an existing virtual space associated with the video call and provides access to the existing virtual space. Specifically, when there is an existing virtual space associated with the virtual call, the data block integration system 102 generates and provides an interface with the existing virtual space on the client device upon selection of option 402. In some cases, a first selection of option 402 (e.g., when there is not an existing virtual space) will generate a virtual space for the video call. After the first selection of option 402, subsequent selections of option 402 (e.g., selections after the data block integration system 102 generates the virtual space) identifies that there is an existing virtual space associated with the meeting data and generate an interface with the existing virtual space.

Based on a selection of option 402, the data block integration system 102 accesses (or receives) meeting data from the smart topic system or the content management system. From these data, the data block integration system 102 generates block content elements for the virtual space. For example, the data block integration system 102 generates a block content element for each of an update block, an action item block, a document block, and a dates block for the virtual space and adds the block content elements to the corresponding data blocks embedded in a virtual space. Indeed, based on the selection of option 402, the data block integration system 102 generates a dynamic virtual space that can intelligently update the virtual space by generating block content elements and adding them to data blocks, without the need for additional human interaction.

As shown in FIG. 4B, the data block integration system 102 provides an option to add meeting data from a video call to an existing virtual space. Indeed, the data block integration system 102 can provide notification 404 within a transcript analysis interface for adding new block content elements to blocks of the existing space. Specifically, the data block integration system 102 analyzes meeting data from a video call, and if the data block integration system 102 determines that the meeting data is associated with an existing virtual space, it provides notification 404. Indeed, the data block integration system 102 can provide the notification 404 immediately in response to detecting a threshold similarity score or cosine distance between a topic of the existing space and a topic of the video call (and based on a selection of the option 402). In some cases, the data block integration system 102 can provide the notification 404 based on detecting that the existing virtual space is accessible by at least a threshold number or percentage of the participants in the video call. For example, the data block integration system 102 can determine that meeting data is associated with an existing virtual space based on determining that the meeting covers the same topics, follows similar agendas, or involves the same participants discussing related issues as existing meeting data (or block content elements) of the existing virtual space. To illustrate, the data block integration system 102 can determine that meeting data has recurring topics, similar agendas, consistent participants, standardized reports of similar structure, repeated issues or action items, common goals or objectives, or regular updates as existing meeting data of an existing virtual space. To do so, the data block integration system 102 can use a large language model to compare data of such types by, for example, extracting and determining distances between topic embeddings, agenda embeddings, action item embeddings, and/or other embeddings encodable from existing content blocks and new video call data.

In one or more embodiments, the data block integration system 102 provides an option to generate a virtual space in notification 404. Specifically, the data block integration system 102 determines that the meeting data from a meeting is not associated with an existing virtual space and provides notification 404 to generate a virtual space utilizing the meeting data based on a user selection of an option in notification 404. In some cases, the data block integration system 102 determines that meeting data is not associated with an existing virtual space based on identifying that there is not a connection between the transcript analysis data and a virtual space for the meeting data and provides notification 404. In other cases, the data block integration system 102 analyzes meeting data and determines that there is no virtual space that covers the same topics (e.g., the embeddings are not within a threshold distance or cosine similarity), follows similar agendas, or involves the same participants discussing related issues, and it provides notification 404 as suggestion to generate a virtual space. Indeed, similar to the selection of option 402, based simply on the selection of an option in notification 404, the data block integration system 102 generates a dynamic virtual space that can intelligently update the virtual space without the need for user interaction.

As shown in FIG. 4C, upon generating virtual space 406, the data block integration system 102 can display virtual space 406 in a virtual space management interface. In particular, the data block integration system 102 displays virtual spaces and provides options for managing virtual spaces within the virtual space management interface. For example, a user account can access virtual spaces associated with a user account and/or can access shared virtual spaces (e.g., collaborative team spaces) from the virtual space management interface. Because the data block integration system 102 (or the content management system) can manage multiple virtual spaces as dynamic collaboration environments, each client device can be associated with multiple virtual spaces, all of which the data block integration system 102 maintains and updates. Moreover, the data block integration system 102 can generate and manage multiple virtual spaces for a group of user accounts, such as by managing virtual spaces for projects of the group of user accounts. Indeed, the data block integration system 102 facilitates viewing, accessing, and interacting with information about various projects through the use of updated dynamic and intelligent virtual spaces.

In addition, the data block integration system 102 can also add an additional virtual space from the virtual space management interface. In particular, the data block integration system 102 provides selection options for generating a virtual space based on receiving a selection of option 408 to add a virtual space. For example, the data block integration system 102 provides options to select virtual calls (and corresponding meeting data) to generate a virtual space. In addition, the data block integration system 102 can provide options to generate a blank virtual space (e.g., without block content elements generated from meeting data) as editable blocks to add action items, summaries, documents, dates, or any other content as described herein.

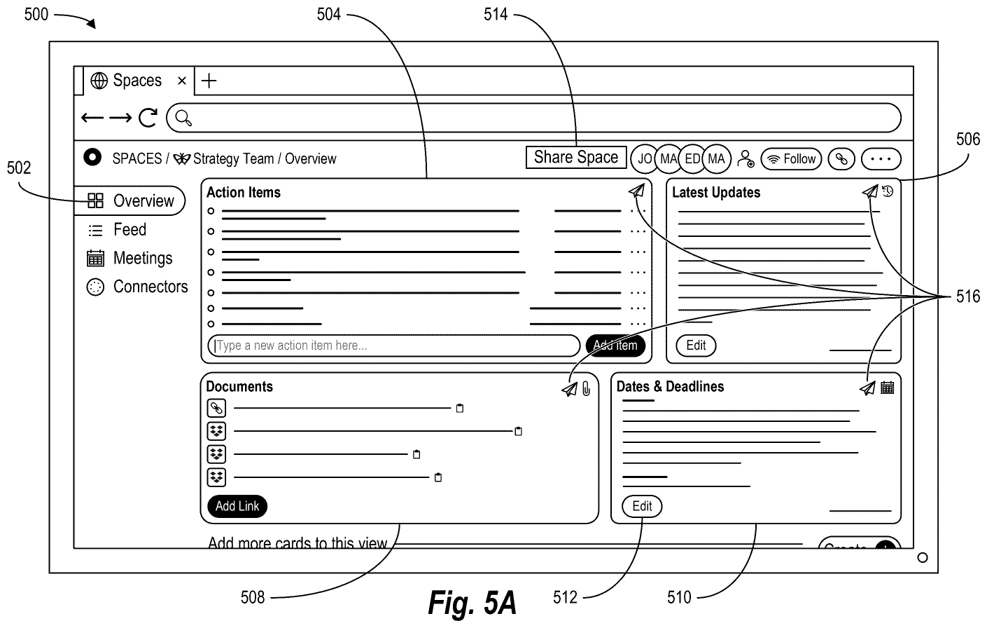

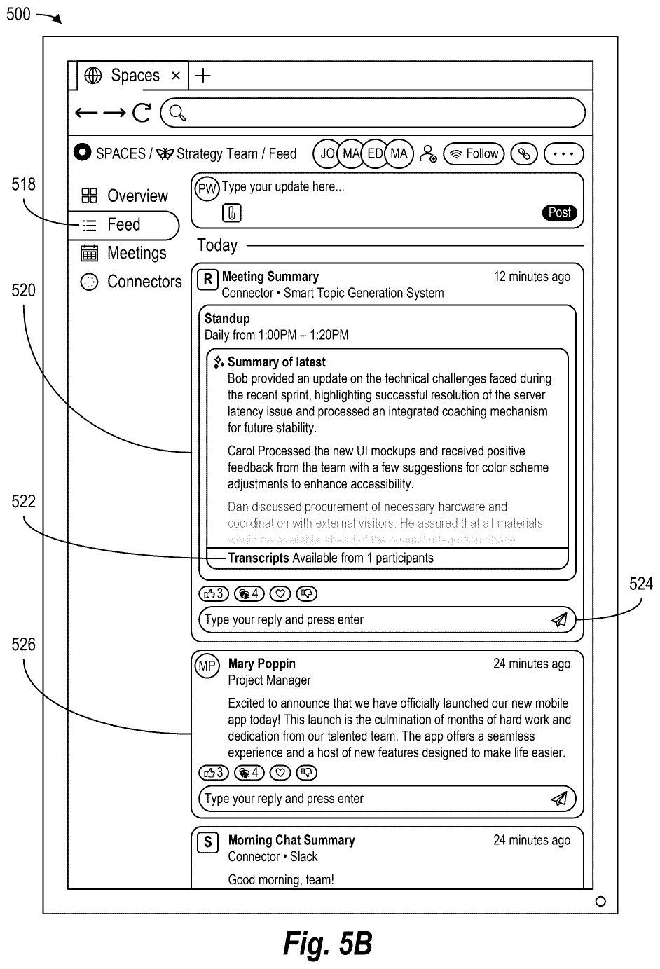

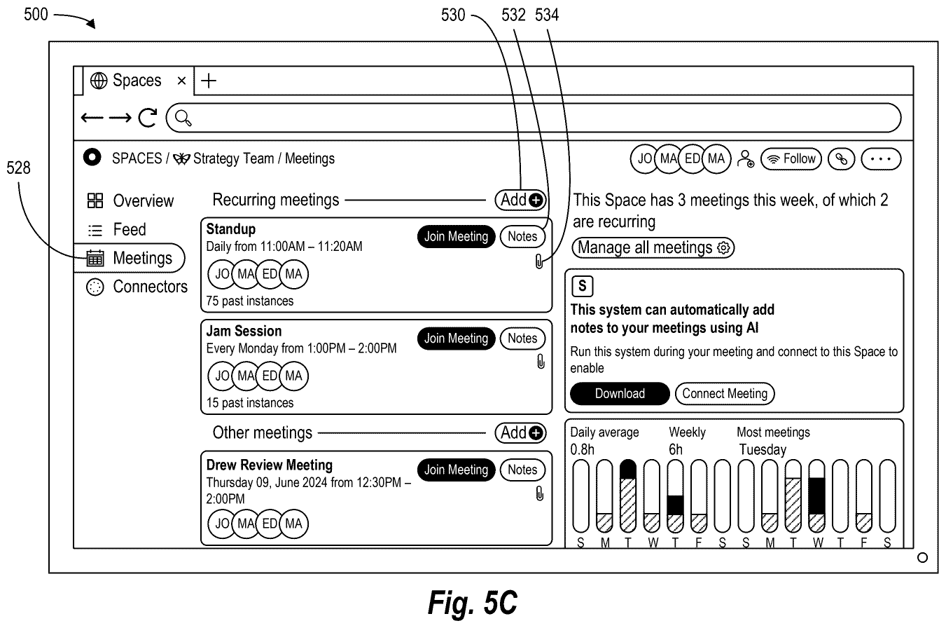

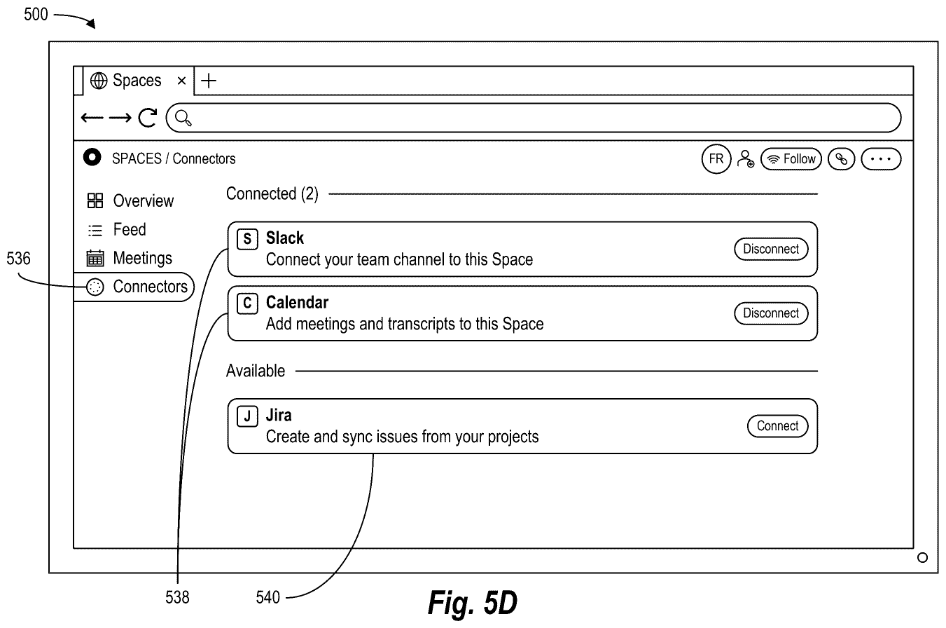

As mentioned, in some embodiments, the data block integration system 102 generates block content elements for a virtual space. Specifically, as described above, a virtual space is a dynamic, multifaceted digital environment that includes data blocks comprising block content elements along with interfaces and elements for interacting with data sources of the virtual space. FIGS. 5A-5D illustrate example graphical user interfaces of a virtual space of a data block integration system 102 in accordance with one or more embodiments. FIG. 5A illustrates an example graphical user interface of an overview tab of a virtual space. FIG. 5B illustrates an example graphical user interface of a feed tab of a virtual space. FIG. 5C illustrates an example graphical user interface of a meetings tab of a virtual space. FIG. 5D illustrates an example graphical user interface of a connectors tab of a graphical user interface.

As shown in FIG. 5A, virtual space 500 includes an overview tab 502. Specifically, overview tab 502 includes data blocks that are multilocational and that include block content elements that can exist in multiple computer locations (e.g., virtual spaces) concurrently, on a single device, and/or across multiple devices. In one or more embodiments, the data block integration system 102 generates a virtual space by generating a default set of data blocks including an action item block, an update block, a document bloc, and a dates block. Further, the data block integration system 102 can generate block content elements that to add to the data blocks (multilocational blocks), along with generating new block content elements when the data block integration system 102 detects additional meeting data from additional video calls associated with the virtual space. Moreover, based on identifying additional information or user interactions, the data block integration system 102 can add or remove data blocks to the default blocks of virtual space 500.

As shown, overview tab 502 of virtual space 500 can include an action item block 504, an update block 506, a document block 508, and a dates block 510. As mentioned, in one or more embodiments, when the data block integration system 102 generates a virtual space (e.g., as described above in relation to FIGS. 4A-4C), the data block generates a default set of data blocks, including an action item block, an update block, a document block, and a dates block for the virtual space, along with corresponding block content elements for each block. For example, the data block integration system 102 generates a prompt (or multiple prompts) instructing a large language model to generate block content elements corresponding to block content specifications for an action item block, an update block, a document block, and a dates block. The data block integration system 102 then adds the block content elements to the corresponding data structures for the data blocks in the interface of the overview tab 502.

As mentioned, and as shown in FIG. 5A, the overview tab 502 includes or depicts action item block 504. Action item block 504 reflects a block content item of action items indicating tasks that a large language model identified in or extracted from meeting data or other third-party data. For example, if a video call participant mentions that someone needs to file a project by a deadline, the data block integration system 102 can generate an action item “file project by deadline” in action item block 504. Moreover, the action items in action item block 504 also comprise selectable options for marking off action items upon completion, generating a comprehensive list of action items from multiple video calls and third-party applications across client devices associated with the virtual space 500.

As also previously mentioned and as illustrated in FIG. 5A, overview tab 502 includes or depicts update block 506. Update block 506 reflects a block content element of updates or summaries from video calls and interactions with third-party applications connected to virtual space 500. For instance, the data block integration system 102 provides meeting data and/or third-party data to the large language model to generate a summary of the latest information, discussions, and decisions regarding the team or project that is the subject of virtual space 500. In some cases, the data block integration system 102 only provides a set number of the most recent data items from which to generate the summary. For example, the data block integration system 102 can generate a summary from the k (e.g., three) most recent instances of meeting data (e.g., the three most recent meetings) or the last k (e.g., three) relevant instances of data from a third-party application (e.g., the last three relevant threads in a third-party messaging application), or a combination of the most recent instances of meeting data and third-party data. In some cases, the data block integration system 102 determines k by defining it in a prompt.

In addition, as previously mentioned and as illustrated in FIG. 5A, overview tab 502 includes or depicts document block 508. Document block 508 reflects a block content element of content items (or links to network locations of content items) extracted from meeting data of one or more video calls and/or third-party data. Specifically, the data block integration system 102 identifies content items from meeting data that are mentioned, discussed, or copied during a video call or documents from a third-party application connected to the virtual space. For example, the data block integration system 102 can extract content items added to a chat thread of a video call application, from meeting agendas, mentioned during a video call, or added to a message (or linked within) a messaging application.

In instances where a content item or link to the content item is directly included in the meeting data or third-party data, the data block integration system 102 can incorporate or embed the content item (or link to the content item) directly in the document block 508. In some instances, the data block integration system 102 identifies mentions of documents but does not include the location of the content item, and the data block integration system 102 utilizes a morphing interface system to identify documents or other content items within a content management system for document block 508. In particular, the data block integration system 102 utilizes a morphing interface system as described in U.S. application Ser. No. 18/342,469 entitled GENERATING AND PROVIDING MORPHING ASSISTANT INTERFACES THAT TRANSFORM ACCORDING TO ARTIFICIAL INTELLIGENCE SIGNALS, filed on Jun. 27, 2023, which is hereby incorporated by reference in its entirety. As also mentioned, and as shown in FIG. 5A, the overview tab depicts or includes dates block 510. Dates block 510 reflects a block content element of dates (or deadlines) from meeting data or third-party data. Specifically, the data block integration system 102 extracts or identifies dates and corresponding items that are mentioned or discussed in video calls or in third-party applications and generates a block content element with the dates. For example, if someone mentions that a meeting is on July 5 during a video call, the data block integration system 102 can add a July 5 meeting to dates block 510.

In one or more embodiments, the data block integration system 102 allows for editing of data blocks of overview tab 502 by receiving user input modifying block content elements and/or based on extracting and updating data for an ongoing video call in real time. Specifically, the data block integration system 102 allows for the editing of data blocks that modify data blocks on client devices associated with the virtual space. For example, as shown, the data block integration system 102 can receive a text input of an action item in action item block 504. Though not shown, the data block integration system 102 also receives a user selection of an action item (e.g., to mark it as complete or to unmark it as incomplete) or a user selection of text of an action item (e.g., to edit the action item). In addition, as shown, the data block integration system 102 can receive a user selection of an edit option 512 in dates block 510 (or a similar option in update block 506 or in another data block). Based on the user selection of the edit option, the data block integration system 102 allows a client device to edit the text of the block content elements of the data block. Moreover, as shown, the data block integration system 102 can receive a user selection of an add link option in document block 508 that, when selected, provides options for adding a document (or a network location for a document) to the block content item. Indeed, by allowing for editing of block content elements in data blocks, the data block integration system 102 provides a dynamic and comprehensive collaboration environment comprising necessary information for a project or team.

Moreover, as shown, in some embodiments, the data block integration system 102 can share data blocks of the virtual space with corresponding block data elements. Specifically, based on a selection of a share option 516 from a data block of virtual space 500, the data block integration system 102 can share individual data blocks as evidence of collaborative efforts of a project or team associated with the virtual space. A client device can send data blocks of the virtual space with an additional client device, even if the additional client device is not associated with the virtual space. For example, a client device can send data blocks to management client devices to indicate the progress of a project.

In addition to sharing data blocks, the data block integration system 102 provides an option 514 to share the virtual space. For example, by selecting option 514, the data block integration system 102 provides options to share the data blocks or a selection of data blocks from the virtual space with an additional client device. In some cases, the data block integration system 102 can provide an option to share the virtual space in a presentation mode (e.g., a view-only mode), where an additional client device can view the virtual space but is unable to edit or modify block content elements of the virtual space.

As shown in FIG. 5B, virtual space 500 includes a feed tab 518. In particular, feed tab 518 reflects a real-time stream of information or data indicating or describing instances of interaction associated with the virtual space. While overview tab 502 (or data blocks within the overview tab) displays an overview of content and/or data associated with the virtual space, feed tab 518 provides a timeline of posts with information and data for each interaction with the virtual space. For example, the data block integration system 102 generates a post with a summary from instances of interaction (e.g., a video call, post on a messaging application) or user-generated update posts in chronological order.

As shown, feed tab 518 includes posts with information, details, or specifics from meeting data or third-party data from interactions associated with the virtual space. For instance, post 520 comprises information from a video call associated with the virtual space. After the video call, when the data block integration system 102 receives meeting data from the video call, the data block integration system 102 generates post 520 for feed tab 518. For example, post 520 can include details, information, and specifics from the video call, such as the date and time of the video call.

As shown, in one or more embodiments, post 520 includes a summary. In particular, the data block integration system 102 utilizes a large language model to generate a summary of the video call and adds it to post 520. For example, a summary of the video can include discussion points, decisions made, action items, assigned tasks, and any follow-up steps or deadlines agreed upon by the participants in the video call. Indeed, a summary in post 520 can include enough details to identify what was discussed in the meeting.

In addition, post 520 can include option 522 which, when selected, displays the source data for post 520. In particular, upon selecting option 522, the data block integration system 102 displays the source data (e.g., as a link to a particular video call) from which the data block integration system 102 generates information in the post, such as a summary or details of the meeting. For example, upon selection of option 522, database 122 displays a transcript from the video call. In some cases, based on a selection of an option to view source data, the data block integration system 102 can generate an interface of a transcript analysis system comprising a transcript (or other meeting data) from a video call.

In addition to providing information from an interaction, the data block integration system 102 provides options for interacting or collaborating regarding post 520. As shown, in some embodiments, post 520 includes an interaction option 524 for users to interact with posts on the feed. For example, from within interaction option 524, client devices can provide comments on the post to others within the virtual space. As another example, the data block integration system 102 can receive a selection of an option within interaction option 524 to send the post to an additional client device.

In one or more embodiments, the data block integration system 102 generates post 526 comprising user input. In particular, post 526 comprises an entry that can include text, images, videos, or links crafted to share thoughts, experiences, updates, or multimedia content with other client devices of the virtual space. For example, post 526 includes information or fosters interaction of client devices of the virtual cases.

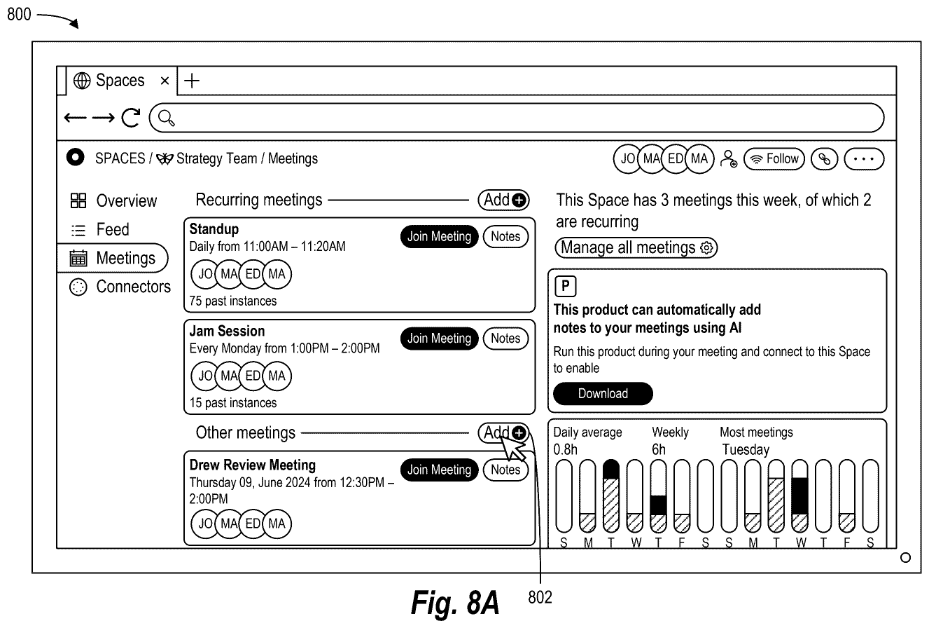

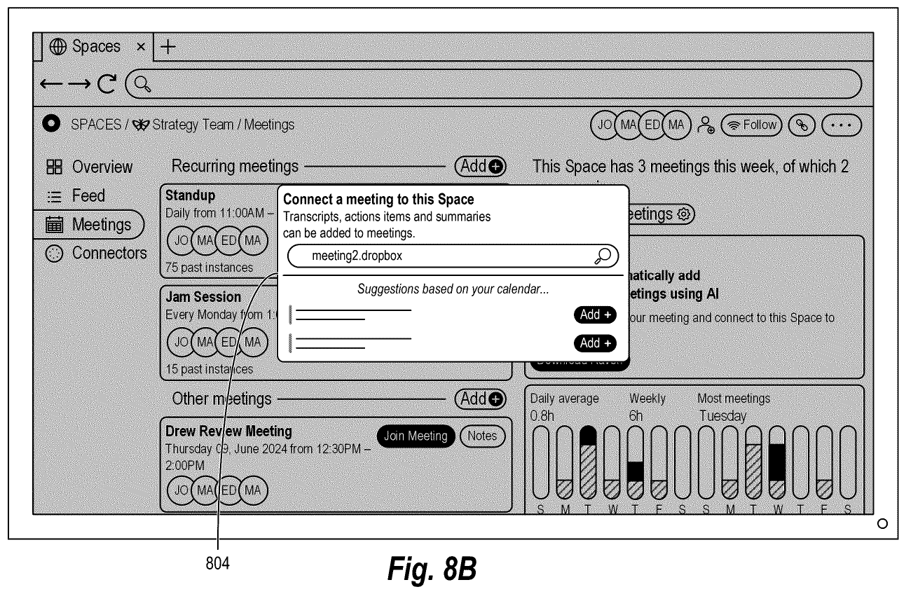

As shown in FIG. 5C, virtual space 500 includes a meetings tab 528. In particular, the data block integration system 102 meetings tab 528 comprises options for managing meetings associated with the virtual space 500. For example, meetings tab 528 includes past and upcoming meetings associated with virtual space 500, along with option 530 to add an additional meeting to the virtual space. Additional information regarding adding meetings to a virtual space is provided below with respect to FIGS. 8A-8B.

In addition, as shown, meetings tab 528 includes an option 530 to add notes to a meeting. For example, based on a selection of option 530, the data block integration system 102 can receive user input about the meeting, such as an agenda for the meeting or other information corresponding to the meeting. Further, as shown, based on option 532, add content items to the meeting. In some cases, the data block integration system 102 utilizes notes from option 530 and content items from option 532 to generate block content elements for data blocks of overview tab 502, such as by adding content items from option 532 to a documents block.

In some embodiments, the data block integration system 102 provides accesses to a meeting from meetings tab 528. In particular, the data block integration system 102 can receive a selection of a meeting in meetings tab 528 and generate a video call interface for the meeting. For example, the data block integration system 102 can integrate with a third-party video call system (e.g., through an API), to which the data block integration system 102 can direct calendar events of meeting and from which the data block integration system 102 receives meeting data.

As shown in FIG. 5D, virtual space 500 includes a connectors tab 536. In particular, from within connectors tab 536, the data block integration system 102 can display information related to third-party applications connected to the virtual space. For example, as shown, connectors tab 536 can indicate third-party applications 538 connected to the virtual space, such as third-party messaging applications (e.g., Slack) or calendar applications (e.g., Google Calendar). In addition, from within connectors tab 536, the data block integration system 102 can manage an established connection with a third-party application. Using the connectors of the connectors tab 536, the data block integration system 102 can generate hybrid data blocks that include block content elements from video calls and other block content elements from connected applications.

Further, the data block integration system 102 can provide options of available applications within connectors tab 536. Specifically, the data block integration system 102 can identify third-party applications 540 with which the data block integration system 102 is connected (e.g., through established APIs, webhooks, or other connectors) and provide options to connect the virtual space to those third-party applications. For example, the data block integration system 102 can provide an option to connect to applications, and, based on receiving user input establishing the connection, the data block integration system 102 can dynamically generate block content elements, posts, and other content items using third-party data.

As previously mentioned, the data block integration system 102 can add a data block to a virtual space. In particular, the data block integration system 102 can add new data blocks or add data blocks from existing virtual spaces. FIGS. 6A-6C illustrate example graphical user interfaces of a data block integration system adding a data block to a virtual space in accordance with one or more embodiments. FIG. 6A illustrates an example graphical user interface for adding a data block or a virtual space to an existing virtual space. FIG. 6B illustrates an example graphical user interface for adding a data block by selecting from a list of data blocks. FIG. 6C illustrates an example graphical user interface of a virtual space with an added data block.

In one or more embodiments, a data block is a card (e.g., a content card) for displaying block content elements. Specifically, the data block integration system 102 displays a data block as a card comprising a block content element. For example, a card can include the rectangular or square-shaped item that holds or displays the block content element and is movable around the virtual space.

The data block integration system 102 provides several options for adding a data block to a virtual space. For example, as shown in FIG. 6A, the data block integration system 102 provides an option 602 to add a data block to virtual space 600. Upon receiving a user selection of option 602, the data block integration system 102 can generate options for adding different types of data blocks, as described below further with respect to FIG. 6B. In addition to a selection of option 602, the data block integration system 102 can receive a data block 604 from an additional virtual space. Specifically, the data block integration system 102 receives user input by dragging a data block from an additional virtual space to virtual space 600. In some cases, upon adding the data block from an additional virtual space, the data block integration system 102 also connects meetings, third-party data, and other data sources to virtual space 600 so that detecting data from the data sources will generate updates to data block 604 and/or virtual space 600.

In addition to adding a data block to a virtual space, the data block integration system 102 can combine virtual spaces. In particular, the data block integration system 102 utilizes a large language model to generate a combined virtual space from two or more virtual spaces. For example, upon selection of option 606, the data block integration system 102 provides options for selecting a virtual space to combine with virtual space 600 and provides meeting data, third-party data, and other data to a large language model to generate combined block content elements for a combined virtual space.

As shown in FIG. 6B, based on a selection of option 602, the data block integration system 102 provides options to generate types of data blocks (or cards). In particular, in response to a user selection of option 602, the data block integration system 102 generates window 608 comprising options to generate data blocks (or cards) corresponding to various block types. For example, the data block integration system 102 provides an option to generate a celebration block. A celebration block can be an editable data block for shared messages or announcements recognizing and commemorating the achievement of a milestone, successful completion of a task, or a significant accomplishment, often intended to express gratitude, boost morale, and encourage further success among team members of the virtual space.

In addition, as shown, the data block integration system 102 can provide an option to generate a project management chart block. For example, the data block integration system 102 can utilize third-party data from a third-party project management application (e.g., Jira) to generate a data block comprising a project management chart of the third-party application. Moreover, the data block integration system 102 provides an option to generate a latest messaging channel activity block. For example, the data block integration system 102 can utilize third-party data from a third-party messaging application (e.g., Slack) and generate a data block comprising messaging threads from the third-party messaging application.

Further, as shown, the data block integration system 102 provides an option to generate a calendar block. For example, the data block integration system 102 can connect to a calendar management application (e.g., Google Calendar) or a calendar of the content management system to receive third-party calendar data to generate a calendar block. In addition, as shown, the data block integration system 102 can provide an option to generate a text block. For example, based on a selection of an option to generate a text block, the data block integration system 102 generates a data block with an editable portion for adding free text to the data block.

Moreover, as shown, the data block integration system 102 provides an option to generate an AI prompt data block. For example, in response to a selection of an option to generate an AI prompt data block, the data block integration system 102 provides an option to receive user input of a customized prompt for a large language model to generate customized block content elements. To illustrate, the data block integration system 102 can receive user input of a prompt instructing a large language model to generate a data block of instances of discussions about a certain aspect of a project, such as a data migration process of a larger project.

Additionally, as shown, the data block integration system 102 can provide an option to generate a transcript block. For example, in response to a selection of an option to generate a transcript block, the data block integration system 102 generates a transcript block of a text transcript from a video call. In some cases, the data block integration system 102 receives a transcript from a smart topic generation system connected to the virtual space.

As shown in FIG. 6C, the data block integration system 102 adds a data block (or card) to a virtual space 600 by modifying data blocks within the virtual space 600. Specifically, the data block integration system 102 adds a data block by moving and/or resizing existing data blocks in virtual space 600. While the data block integration system 102 can modify the size or position of existing data blocks, the data block integration system 102 maintains (e.g., does not modify) block content elements in existing data blocks. For example, as shown, in response to a selection of an option to generate a text block 610, the data block integration system 102 adds the data block to virtual space 600 by resizing and moving a document block and a dates block.

As previously mentioned, the data block integration system 102 generates a virtual space by generating a document block, an update block, an action item block, and a dates block. In one or more embodiments, the data block integration system 102 can generate additional data blocks, such as a suggestion block, an application block, and a transcript block. FIGS. 7A-7B illustrate an example graphical user interface of various data block types for a virtual space of a data block integration system and generating a combined transcript for a transcript block in accordance with one or more embodiments. FIG. 7A illustrates an example graphical user interface of a virtual space with a suggestion block, an application block, and a transcript block. FIG. 7B illustrates an example diagram of the data block integration system 102 generating a combined transcript for a transcript block.

As shown in FIG. 7A, the data block integration system 102 can include an active document block 702 in virtual space 700. Specifically, the active document block 702 reflects documents that are currently being accessed or discussed during a video call. In particular, the data block integration system 102 determines that a certain document (or other content item) is displayed, accessed, shared, or otherwise provided during a video call and update the active document block 702 with one or more documents shared during the video call. For example, based on identifying the document that is being shared the data block integration system 102 can generate a block content element indicating network locations of the document (e.g., within the content management system). To illustrate, the data block integration system 102 can identify a document based on analyzing transcript data referencing the document during the video call, receiving a direct upload, copy, or share of the document within video call system, monitoring screen sharing, monitoring network traffic, or receiving real-time editing of the document.

As shown in FIG. 7A, the data block integration system 102 can include a suggestion block 704 in virtual space 700. Specifically, a suggestion block includes block content elements of intelligent suggestions generated by a large language model from meeting data from various video calls and third-party applications associated with the virtual space. For example, intelligent suggestions can include adding extra time (e.g., fifteen minutes) to a meeting that frequently goes longer than the scheduled time, generating an agenda for an upcoming meeting, or suggesting skipping a meeting based on identifying that there is not relevant content for a video call (e.g., based on completed action items and updates in the virtual space).

In addition to suggested block content elements, the data block integration system 102 can add a block suggestion to the virtual space 700. Specifically, the data block integration system 102 identifies patterns in data that correspond to a data block type and provide a suggested data block for the virtual space 700 corresponding to the data block type. For example, the data block integration system 102 can identify that user accounts of the virtual space 700 utilize a messaging system a threshold amount (e.g., k number of messaging threads per day) and provide a suggested application block reflecting messaging threads of the messaging system. In some cases, the data block integration system 102 adds the suggested data block to the virtual space 700 (e.g., by rearranging the data blocks of the virtual space to include the suggested data block).

In one or more embodiments, the data block integration system 102 generates an agenda for suggestion block 704. In particular, based on meeting data from previous video calls, the data block integration system 102 can identify suggested topics for discussion during a meeting and generate an agenda with the suggested topics. For example, if meeting data from a previous meeting indicated that the next meeting should an update on a topic, the data block integration system 102 can include an item on the agenda for discussing the topic. As another example, the data block integration system 102 can determine that certain topics are discussing during sessions of a recurring meeting and generate an agenda based on commonly discussed topics of the recurring meeting.

As also shown, the data block integration system 102 can comprise an applications block 706 in virtual space 700. Specifically, an application block 706 can reflect block content elements generated from third-party data from a third-party application connected to the virtual space. For example, an applications block 706 can include block content elements of messaging threads from a third-party messaging application, a project management chart from a third-party project management application, or calendar data from a third-party calendar application. In some cases, the data block integration system 102 extracts the most recent third-party data from the third-party application, such as the k most recent relevant messaging threads (e.g., three most recent messaging threads with 350 characters or at least five replies) or most recent project updates.

In addition, as shown, the data block integration system 102 can include a transcript block 708 in virtual space 700. In particular, the data block integration system 102 generates a transcript block 708 reflecting a transcript from a video call. For example, the data block integration system 102 can receive a transcript from a smart topic generation system or another transcription system connected to virtual space 700. While transcriptions or other data are not editable in a smart topic generation system, a transcript block is editable, so errors and mistakes can be corrected based on user input. For instance, if the smart topic generation system or the transcription system does not correctly capture data (e.g., names or other information), the transcript can be edited in the transcript block.

In one or more embodiments, the data block integration system 102 generates a combined transcript for the transcript block. Specifically, the data block integration system 102 generates a combined transcript from two or more transcripts to remedy missing data and/or inaccuracies or to identify speakers in the transcript of the video call. FIG. 7B illustrates an example diagram of generating a combined transcript from two or more transcripts.

As shown, the data block integration system 102 receives a first transcript 712 and a second transcript 714 from video call 710. In particular, the data block integration system 102 identifies errors or mistakes in first transcript 712 and/or second transcript 714 and generates combined transcript 716 utilizing data from first transcript 712 and second transcript 714. For example, based on comparing first transcript 712 and second transcript 714, the data block integration system 102 can identify that first transcript 712 and second transcript 714 are each missing data and generate combined transcript 716 as a single transcript that comprises a full record of data and remedying the missing data in each transcript. In one or more embodiments, the data block integration system 102 utilizes a large language model to generate combined transcript 716. Specifically, the data block integration system 102 generates a prompt with two or more transcripts and instructions to combine the transcripts and generate combined transcript 716.

In addition to generating a combined transcript to fix errors or omissions in two or more transcripts, the data block integration system 102 can generate combined transcript 716 to identify speakers in a video call. Specifically, the data block integration system 102 compares first transcript 712 to additional transcript 714 and aligns the two transcripts based on matching audio data and adding corresponding data that is missing (or corrupted) data in one transcript from the other transcript. For example, the data block integration system 102 can receive the first transcript 712 utilizing voice identification or from a dedicated voice input (e.g., headphones) from a first client device and the additional transcript 714 utilizing voice identification from a second client device and the data block integration system 102. The data block integration system 102 attributes each client device and identifies portions of the transcripts that are missing data and adding the corresponding portions to generates combined transcript 716.

As previously mentioned, the data block integration system 102 can add a video call to a virtual space. In particular, the data block integration system 102 connects a video call to a virtual space from which to receive meeting data to generate block content elements. FIGS. 8A-8B illustrate example graphical user interfaces depicting a data block integration system connecting a video call to a virtual space in accordance with one or more embodiments FIG. 8A illustrates an example graphical user interface for selecting an option to add a video call. FIG. 8B illustrates an example graphical user interface for selecting a video call to add to the virtual space.

As shown in FIG. 8A, the data block integration system 102 provides option 802 in a meeting tab for adding a video call or other digital meeting to virtual space 800. In addition to an option to add a meeting, the data block integration system 102 generates or adds an option to add a video call or other digital meeting based on identifying that a video call or other digital meeting is associated with the digital space. For example, the data block integration system 102 can analyze agendas, prospective participants, content items, or other data associated with video calls or other digital meetings that the video calls are associated with the virtual space.

As shown in FIG. 8B, based on a selection of an option to add a video call or other digital meeting to virtual space 800, the data block integration system 102 generates options 804 for selecting a video call to add to a virtual space. For example, options 804 provide a search bar to search for video calls and other meetings to add to the virtual space. In addition, options 804 can also provide suggestions for video calls or digital meetings based on analyzing a calendar connected to virtual space 800. For instance, virtual space 800 can be connected to a calendar system (e.g., a third-party or native calendar system) that provides indications of video calls or other digital meetings and the data block integration system 102 extracts indications of the video calls or other digital meetings from the calendar system as suggested meetings to add to virtual space 800.

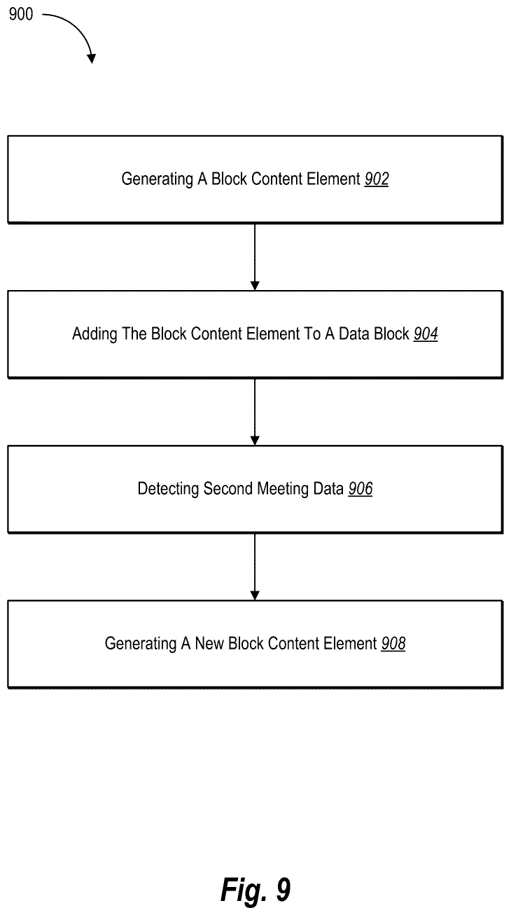

FIGS. 1-8B, the corresponding text, and the examples provide a number of different methods, systems, devices, and non-transitory computer-readable media of the data block integration system 102. In addition to the foregoing, one or more embodiments can also be described in terms of flowcharts comprising acts for accomplishing a particular result, as shown in FIG. 9. FIG. 9 may be performed with more or fewer acts. Further, the acts may be performed in differing orders. Additionally, the acts described herein may be repeated or performed in parallel with one another or parallel with different instances of the same or similar acts.

As mentioned, FIG. 9 illustrates a flowchart of a series of acts 900 for generating block content elements from meeting data of multiple video calls to add to data blocks of a virtual space. in accordance with one or more embodiments. While FIG. 9 illustrates acts according to one embodiment, alternative embodiments may omit, add to, reorder, and/or modify any of the acts shown in FIG. 9. The acts of FIG. 9 can be performed as part of a method. Alternatively, a non-transitory computer-readable medium can comprise instructions that, when executed by one or more processors, cause a computing device to perform the acts of FIG. 9. In some embodiments, a system can perform the acts of FIG. 9.

As shown in FIG. 9, the series of acts 900 includes an act 902 of generating a block content element, an act 904 of adding the block content element to a data block, an act 906 of detecting a second meeting, and an act 908 of generating a new block content element.

In particular, the act 902 can include generating, using a large language model to process first meeting data from a first video call, a block content element corresponding to a block type, the act 904 can include adding the block content element to a data block within a virtual space associated with the first video call, the act 906 can include detecting second meeting data from a second video call associated with the virtual space, and the act 908 can include and in response to detecting the second meeting data, generating, using the large language model to process the second meeting data, a new block content element corresponding to the block type of the data block in the virtual space.

In one or more embodiments, the series of acts 900 includes updating the data block within the virtual space by adding the new block content element to the data block.

In addition, in one or more embodiments, the series of acts 900 includes generating the block content element further comprises: receiving a prompt instructing the large language model to generate the block content element based on block content specifications corresponding to the block type and extracted data from the first meeting data; and providing the prompt to the large language model to generate the block content element.

Also, in one or more embodiments, the series of acts 900 includes wherein adding the block content element to the data block further comprises: receiving, from a transcript analysis interface associated with the virtual space, a user selection of an option to generate the data block within the virtual space; generating the block content element corresponding to the block type in response to receiving the user selection of the option to generate the data block; and adding the data block with the block content element to the virtual space.

Further, in one or more embodiments, the series of acts 900 includes wherein adding the block content element to the data block further comprises: determining, based on analyzing the first meeting data of the first video call, that the first video call is associated with an existing virtual space; and adding the block content element to an existing data block within the existing virtual space.

Moreover, in one or more embodiments, the series of acts 900 includes extracting, from a third-party application connected to the virtual space, third-party data associated with the virtual space; and adding the third-party data to an additional data block within the virtual space. Also, in one or more embodiments, the series of acts 900 includes generating the block content element corresponding to the block type by generating, using the large language model, a summary of the first video call and the second video call for a summary block; and adding the block content element to the data block by adding the summary to the data block.

In addition, in one or more embodiments, the series of acts 900 includes extracting an indication of a document from the second meeting data from of the second video call; determining a network location for the document within a content management system associated with the virtual space; and generating a block content element corresponding to a document block comprising a document element for surfacing the document within the virtual space.

Further, in one or more embodiments, the series of acts 900 includes receiving, from a client device associated with the virtual space, a request to generate an additional data block within the virtual space, the request comprising a prompt for the large language model to generate an additional block content element corresponding to an additional block type; generating, using the large language model and based on the prompt, the additional block content element corresponding to the additional block type; and generating the additional data block within the virtual space with the additional block content element.

Additionally, in one or more embodiments, the series of acts 900 includes generating, using a large language model to process first meeting data from a first video call, a block content element corresponding to a block type; adding the block content element to a data block within a virtual space associated with the first video call; detecting second meeting data from a second video call associated with the virtual space; in response to detecting the second meeting data, generating, using the large language model to process the second meeting data, a new block content element corresponding to the block type of the data block in the virtual space; and updating, within the virtual space, the data block by adding the new block content element to the data block.

Also, in one or more embodiments, the series of acts 900 includes updating the data block by receiving the second meeting data from the second video call during the second video call; generating, using the large language model to process the second meeting data during the second video call, the new block content element; detecting that the new block content element comprises new data; and based on detecting that the new block content element comprises new data, updating the data block by adding the new block content element to the data block.

Further, in one or more embodiments, the series of acts 900 includes generating the block content element corresponding to a block type by generating: a first block content element corresponding to an update block type comprising a summary of updates extracted from the first meeting data; a second block content element corresponding to an action item block type comprising action items extracted from the first meeting data; a third block content element corresponding to a document block type comprising document elements for surfacing documents within the virtual space; and a fourth block content element corresponding to a dates block type comprising dates corresponding to deadlines extracted from the first meeting data. Additionally, in one or more embodiments, the series of acts 900 includes adding the first block content element to an update block within the virtual space; adding the second block content element to an action block within the virtual space; adding the third block content element to a document block within the virtual space; and adding the fourth block content element to a dates block within the virtual space.

Moreover, in one or more embodiments, the series of acts 900 includes generating the new block content element by: detecting that the second meeting data from the second video call comprises data that corresponds to the first meeting data from the first video call; and generating the new block content element based on detecting that the second meeting data from the second meeting data comprises data that corresponds to the first meeting data from the first video call.

In addition, in one or more embodiments, the series of acts 900 includes updating the data block by: removing the block content element from the data block in response to generating the new block content element; and adding the new block content element to the data block.

Additionally, in one or more embodiments, the series of acts 900 includes generating, using a large language model to process first meeting data from a first video call, a block content element corresponding to a block type based on receiving a user selection of an option generate a virtual space from a transcript analysis interface; generating the virtual space by generating a data block including the block content element; detecting second meeting data from a second video call associated with the virtual space; and in response to detecting the second meeting data, generating, using the large language model to process the second meeting data, a new block content element corresponding to the block type of the data block in the virtual space.

Further, in one or more embodiments, the series of acts 900 includes generating the block content element by: generating a combined transcript from a first transcript of the first video call and an additional transcript of the first video call; and generate the block content element by using the large language model to process the combined transcript.

Moreover, in one or more embodiments, the series of acts 900 includes generating the block content element corresponding to the block type by: determining a block type for a data block indicating a digital content to include in the block content element; and generating, depicted within the virtual space, an interface element for the digital content corresponding to the block type.

In addition, in one or more embodiments, the series of acts 900 includes generating a first transcript from the first video call; and adding the first transcript to a transcript block within the virtual space.

Also, in one or more embodiments, the series of acts 900 includes generating the new block content element by: generating, using the large language model, a meeting agenda based on the first video call and the second video call; and adding the meeting agenda to an additional data block in the virtual space.[first dependent claim]. [Add additional/alternate claim language for foreign jurisdictions if appropriate]

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 10 illustrates a block diagram of an example computing device 1000 that may be configured to perform one or more of the processes described above. One will appreciate that one or more computing devices, such as the computing device 1000 may represent the computing devices described above (e.g., server(s) 106, client device(s) 110a-110n, or third-party server(s) 118). In one or more embodiments, the computing device 1000 may be a mobile device (e.g., a mobile telephone, a smartphone, a PDA, a tablet, a laptop, a camera, a tracker, a watch, a wearable device, etc.). In some embodiments, the computing device 1000 may be a non-mobile device (e.g., a desktop computer or another type of client device). Further, the computing device 1000 may be a server device that includes cloud-based processing and storage capabilities.

As shown in FIG. 10, the computing device 1000 can include one or more processor(s) 1002, memory 1004, a storage device 1006, input/output interfaces 1008 (or “I/O interfaces 1008”), and a communication interface 1010, which may be communicatively coupled by way of a communication infrastructure (e.g., bus 1012). While the computing device 1000 is shown in FIG. 10, the components illustrated in FIG. 10 are not intended to be limiting. Additional or alternative components may be used in other embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 includes hardware for executing instructions, such as those making up a computer program. As an example, and not by way of limitation, to execute instructions, the processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 includes storage for storing data or instructions. As an example, and not by way of limitation, the storage device 1006 can include a non-transitory storage medium described above. The storage device 1006 may include a hard disk drive (HDD), flash memory, a Universal Serial Bus (USB) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. These I/O interfaces 1008 may include a mouse, keypad or a keyboard, a touch screen, camera, optical scanner, network interface, modem, other known I/O devices or a combination of such I/O interfaces 1008. The touch screen may be activated with a stylus or a finger.

The I/O interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can include hardware, software, or both that connects components of computing device 1000 to each other.

FIG. 11 is a schematic diagram illustrating environment 1100 within which one or more implementations of the data block integration system 102 can be implemented. For example, the data block integration system 102 may be part of a content management system 1102 (e.g., the content management system 104). Content management system 1102 may generate, store, manage, receive, and send digital content (such as digital content items). For example, content management system 1102 may send and receive digital content to and from client devices 1106 by way of network 1104. In particular, content management system 1102 can store and manage a collection of digital content. Content management system 1102 can manage the sharing of digital content between computing devices associated with a plurality of users. For instance, content management system 1102 can facilitate a user sharing a digital content with another user of content management system 1102.

In particular, content management system 1102 can manage synchronizing digital content across multiple client devices 1106 associated with one or more users. For example, a user may edit digital content using client device 1106. The content management system 1102 can cause client device 1106 to send the edited digital content to content management system 1102. Content management system 1102 then synchronizes the edited digital content on one or more additional computing devices.

In addition to synchronizing digital content across multiple devices, one or more implementations of content management system 1102 can provide an efficient storage option for users that have large collections of digital content. For example, content management system 1102 can store a collection of digital content on content management system 1102, while the client device 1106 only stores reduced-sized versions of the digital content. A user can navigate and browse the reduced-sized versions (e.g., a thumbnail of a digital image) of the digital content on client device 1106. In particular, one way in which a user can experience digital content is to browse the reduced-sized versions of the digital content on client device 1106.

Another way in which a user can experience digital content is to select a reduced-size version of digital content to request the full-or high-resolution version of digital content from content management system 1102. In particular, upon a user selecting a reduced-sized version of digital content, client device 1106 sends a request to content management system 1102 requesting the digital content associated with the reduced-sized version of the digital content. Content management system 1102 can respond to the request by sending the digital content to client device 1106. Client device 1106, upon receiving the digital content, can then present the digital content to the user. In this way, a user can have access to large collections of digital content while minimizing the amount of resources used on client device 1106.

Client device 1106 may be a desktop computer, a laptop computer, a tablet computer, a personal digital assistant (PDA), an in-or out-of-car navigation system, a handheld device, a smart phone or other cellular or mobile phone, or a mobile gaming device, other mobile device, or other suitable computing devices. Client device 1106 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1104.

Network 1104 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1106 may access content management system 1102.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating, using at least one large language model to process first meeting data from a first video call, a block content element corresponding to a block type;
adding the block content element to a data block within a virtual space associated with the first video call;
detecting second meeting data from a second video call associated with the virtual space; and
in response to detecting the second meeting data, generating, using the at least one large language model to process the second meeting data, a new block content element corresponding to the block type of the data block in the virtual space.

2. The computer-implemented method of claim 1, further comprising updating the data block within the virtual space by adding the new block content element to the data block.

3. The computer-implemented method of claim 1, wherein generating the block content element further comprises:
receiving a prompt instructing the at least one large language model to generate the block content element based on block content specifications corresponding to the block type and extracted data from the first meeting data; and
providing the prompt to the at least one large language model to generate the block content element.

4. The computer-implemented method of claim 1, wherein adding the block content element to the data block further comprises:
receiving, from a transcript analysis interface associated with the virtual space, a user selection of an option to generate the data block within the virtual space;
generating the block content element corresponding to the block type in response to receiving the user selection of the option to generate the data block; and
adding the data block with the block content element to the virtual space.

5. The computer-implemented method of claim 1, wherein adding the block content element to the data block further comprises:
determining, based on analyzing the first meeting data of the first video call, that the first video call is associated with an existing virtual space; and
adding the block content element to an existing data block within the existing virtual space.

6. The computer-implemented method of claim 1, further comprising:
extracting, from a third-party application connected to the virtual space, third-party data associated with the virtual space; and
adding the third-party data to an additional data block within the virtual space.

7. The computer-implemented method of claim 1, further comprising:
generating the block content element corresponding to the block type by generating, using the at least one large language model, a summary of the first video call and the second video call for a summary block; and
adding the block content element to the data block by adding the summary to the data block.

8. The computer-implemented method of claim 1, further comprising:
extracting an indication of a document from the second meeting data from of the second video call;
determining a network location for the document within a content management system associated with the virtual space; and
generating a block content element corresponding to a document block comprising a document element for surfacing the document within the virtual space.

9. The computer-implemented method of claim 1, further comprising:
receiving, from a client device associated with the virtual space, a request to generate an additional data block within the virtual space, the request comprising a prompt for the at least one large language model to generate an additional block content element corresponding to an additional block type;
generating, using the at least one large language model and based on the prompt, the additional block content element corresponding to the additional block type; and
generating the additional data block within the virtual space with the additional block content element.

10. A non-transitory computer-readable medium storing instructions that, when executed by at least one processor, cause a computer system to:
generate, using at least one large language model to process first meeting data from a first virtual meeting, a block content element corresponding to a block type;
add the block content element to a data block within a virtual space associated with the first virtual meeting;
detect second meeting data from a second virtual meeting associated with the virtual space;
in response to detecting the second meeting data, generate, using the at least one large language model to process the second meeting data, a new block content element corresponding to the block type of the data block in the virtual space; and
update, within the virtual space, the data block by adding the new block content element to the data block.

11. The non-transitory computer-readable medium of claim 10, further comprising instructions that, when executed by the at least one processor, cause the computer system to update the data block by:
receiving the second meeting data from the second virtual meeting during the second virtual meeting;
generating, using the at least one large language model to process the second meeting data during the second virtual meeting, the new block content element;
detecting that the new block content element comprises new data; and
based on detecting that the new block content element comprises new data, updating the data block by adding the new block content element to the data block.

12. The non-transitory computer-readable medium of claim 10, further comprising instructions that, when executed by the at least one processor, cause the computer system to generate the block content element corresponding to a block type by generating:
a first block content element corresponding to an update block type comprising a summary of updates extracted from the first meeting data;
a second block content element corresponding to an action item block type comprising action items extracted from the first meeting data;
a third block content element corresponding to a document block type comprising document elements for surfacing documents within the virtual space; and
a fourth block content element corresponding to a dates block type comprising dates corresponding to deadlines extracted from the first meeting data.

13. The non-transitory computer-readable medium of claim 12, further comprising instructions that, when executed by the at least one processor, cause the computer system to:
add the first block content element to an update block within the virtual space;
add the second block content element to an action item block within the virtual space;
add the third block content element to a document block within the virtual space; and
add the fourth block content element to a dates block within the virtual space.

14. The non-transitory computer-readable medium of claim 10, further comprising instructions that, when executed by the at least one processor, cause the computer system to generate the new block content element by:
detecting that the second meeting data from the second virtual meeting comprises data that corresponds to the first meeting data from the first virtual meeting; and
generating the new block content element based on detecting that the second meeting data from the second virtual meeting comprises data that corresponds to the first meeting data from the first virtual meeting.

15. The non-transitory computer-readable medium of claim 10, further comprising instructions that, when executed by the at least one processor, cause the computer system to update the data block by:
removing the block content element from the data block in response to generating the new block content element; and
adding the new block content element to the data block.

16. A system comprising:
at least one processor; and
at least one non-transitory computer-readable storage medium storing instructions that, when executed by the at least one processor, cause the system to:
generate, using at least one large language model to process first meeting data from a first video call, a block content element corresponding to a block type based on receiving a user selection of an option generate a virtual space from a transcript analysis interface;
generate the virtual space by generating a data block including the block content element;
detect second meeting data from a second video call associated with the virtual space; and
in response to detecting the second meeting data, generate, using the at least one large language model to process the second meeting data, a new block content element corresponding to the block type of the data block in the virtual space.

17. The system of claim 16, further comprising instructions that, when executed by the at least one processor, cause the system to generate the block content element by:
generating a combined transcript from a first transcript of the first video call and an additional transcript of the first video call; and
generate the block content element by using the at least one large language model to process the combined transcript.

18. The system of claim 16, further comprising instructions that, when executed by the at least one processor, cause the system to generate the block content element corresponding to the block type by:
determining a block type for a data block indicating a digital content to include in the block content element; and
generating, depicted within the virtual space, an interface element for the digital content corresponding to the block type.

19. The system of claim 16, further comprising instructions that, when executed by the at least one processor, cause the system to:
generate a first transcript from the first video call; and
add the first transcript to a transcript block within the virtual space.

20. The system of claim 16, further comprising instructions that, when executed by the at least one processor, cause the system to generate the new block content element by:
generating, using the at least one large language model, a meeting agenda based on the first video call and the second video call; and
adding the meeting agenda to an additional data block in the virtual space.
